(19) United States
(12) Patent Application Publication
(10) Pub. No.: US 2010/0277675 A1
(43) Pub. Date: Nov. 4, 2010

(54) POLARIZING PLATE, LIQUID CRYSTAL PANEL, AND LIQUID CRYSTAL DISPLAY

(75) Inventors: Masatsugu Higashi, Osaka (JP); Nao Murakami, Osaka (JP); Kazuki Uwada, Osaka (JP); Takashi Kumano, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/746,358

(22) PCT Filed: Oct. 21, 2008
(86) PCT No.: PCT/JP2008/069006

§ 371 Date: Jul. 15, 2010

(30) Foreign Application Priority Data
Dec. 5, 2007 (JP) 2007-314876
Jun. 17, 2008 (JP) 2008-157323

(51) Int. Cl. G02F 1/1335; G02B 5/30; G02B 1/08

(52) U.S. Cl. 349/96; 359/485

(57) ABSTRACT

A polarizing plate in which even slight luminance nonuniformity is provided from occurring is provided. In this polarizing plate 10, a transparent protective film 11, a polarizer 12, and an optical compensation layer 13 are laminated in this order. The moisture permeability of the transparent protective film 11 is different from that of the optical compensation layer 13. The optical compensation layer 13 is a retardation film containing at least one resin selected from norbornene resins, polyvinyl acetal resins, polyester resins, polypropylene resins, polycarbonate resins, and acrylic resins. The moisture content of the polarizing plate 10 is not more than 3%.

### TECHNICAL FIELD

The present invention relates to a polarizing plate, a liquid crystal panel, and a liquid crystal display.

### BACKGROUND ART

Liquid crystal displays (LCDs) are devices that display characters and images utilizing electro-optical characteristics of liquid crystal molecules, and they have been used widely in mobile phones, notebook computers, liquid crystal televisions, etc. In a LCD, a liquid crystal panel having a polarizing plate arranged on each side of a liquid crystal cell generally is used. An example of the configuration of the liquid crystal cell is shown in the schematic sectional view of FIG. 4. As shown in FIG. 4, the liquid crystal cell 41 is configured so that spacers 412 are arranged between a pair of substrates 411a and 411b, and a liquid crystal layer 413 is held in a space that is formed between the pair of substrates 411a and 411b by the spacers 412. Although not shown in the drawing, one of the substrates is provided with a switching element (e.g., TFT) for controlling electro-optical characteristics of the liquid crystal molecules, a scanning line for supplying gate signals to the switching element, and a signal line for supplying source signals to the switching element. As a driving mode of a liquid crystal cell used in a LCD, the vertical alignment (VA) mode has been known (see Patent Document 1, for example). In the liquid crystal cell of this VA mode, liquid crystal molecules are aligned substantially vertically to a substrate surface in the non-driven state, so that light passes through a liquid crystal layer with its polarization plane substantially unchanged. Thus, the VA mode liquid crystal cell can achieve substantially perfect black display in the non-driven state.

However, as LCDs (for example, liquid crystal television and the like) come to achieve higher resolution in recent years, demand arises for reduction in black luminance within a plane of liquid crystal panels. Thus, even slight light leakage from a polarizing plate is seen as a problem.

[Patent Document 1] JP 2004-46065 A

### BRIEF SUMMARY OF THE INVENTION

With the foregoing in mind, it is an object of the present invention to provide a polarizing plate in which even slight luminance nonuniformity is prevented from occurring by suppressing light leakage from the polarizing plate as much as possible, and also to provide a liquid crystal panel and a liquid crystal display each using the polarizing plate.

In order to achieve the above object, a polarizing plate according to the present invention is a polarizing plate including a transparent protective film, a polarizer, and an optical compensation layer. The transparent protective film, the polarizer, and the optical compensation layer are laminated in this order. A moisture permeability of the transparent protective film is different from a moisture permeability of the optical compensation layer. The optical compensation layer is a retardation film containing at least one resin selected from the group consisting of norbornene resins, polyvinyl acetal resins, polyester resins, polypropylene resins, polycarbonate resins, and acrylic resins. A moisture content of the polarizing plate is not more than 3%.

A first liquid crystal panel according to the present invention is a liquid crystal panel including a liquid crystal cell and a polarizing plate. The polarizing plate is the polarizing plate according to the present invention, and the polarizing plate is arranged on at least one side of the liquid crystal cell with the optical compensation layer being on the liquid crystal cell side.

A second liquid crystal panel according to the present invention is a liquid crystal panel including: a first polarizing plate; a second polarizing plate; and a liquid crystal cell. The first polarizing plate is the polarizing plate according to the present invention. In the first polarizing plate, the transparent protective film is a first transparent protective film, the polarizer is a first polarizer, and the optical compensation layer is a first optical compensation layer. In the second polarizing plate, a second transparent protective film, a second polarizer, and a second optical compensation layer are laminated in this order. The first polarizing plate is arranged on a visible side of the liquid crystal cell with the first optical compensation layer being on the liquid crystal cell side. The second polarizing plate is arranged on a backlight side of the liquid crystal cell with the second optical compensation layer being on the liquid crystal cell side.

A liquid crystal display according to the present invention includes a polarizing plate or a liquid crystal panel. In this liquid crystal display, the polarizing plate is the polarizing plate according to the present invention, and the liquid crystal panel is the first or second liquid crystal panel according to the present invention.

The inventors of the present invention discovered, through a series of studies, the cause of the occurrence of luminance nonuniformity in conventional polarizing plates. Specifically, in a conventional polarizing plate, strain is generated by the heat (about 40° C.) when a backlight is on. Then, owing to the strain, the absorption axis of a polarizer is displaced, or the axis and/or retardation of an optical compensation layer is changed. This deteriorates the uniformity in display characteristics of the polarizing plate, resulting in the luminance nonuniformity. In order to solve this problem, the inventors of the present invention made further studies. They focused attention on the fact that a transparent protective film and an optical compensation layer have different moisture permeabilities, and discovered that, by setting the moisture content of a polarizing plate including them as components to not more than 3%, the occurrence of the luminance nonuniformity is prevented. Thus, the inventors of the present invention achieved the present invention. Since the polarizing plate of the present invention has a moisture content of not more than 3%, the strain due to the heat when the backlight is on is suppressed. As a result, in the polarizing plate of the present invention, the luminance nonuniformity is prevented from occurring. It is to be noted that the mechanism by which the occurrence of the luminance nonuniformity is prevented is conjecture, and the present invention is by no means limited thereby.

### BRIEF DESCRIPTION OF DRAWINGS

FIG. 1 is a schematic sectional view showing an example of the configuration of a polarizing plate of the present invention.

FIG. 2 is a schematic sectional view showing an example of the configuration of a first liquid crystal panel of the present invention.

FIG. 3 is a schematic sectional view showing an example of the configuration of a second liquid crystal panel of the present invention.

FIG. 4 is a schematic sectional view showing an example of the configuration of a liquid crystal cell included in the liquid crystal panel of the present invention.

FIG. 5 is a schematic sectional view showing an example of the configuration of a liquid crystal display of the present invention.

FIG. 6 is a graph showing the change with time in strain of a polarizing plate in the TD direction in examples of the present invention.

FIG. 7 is a graph showing the change with time in strain of the polarizing plate in the MD direction in the examples of the present invention.

FIG. 8 is a graph showing the change with time in strain of a polarizing plate in the TD direction in other examples of the present invention.

FIG. 9 is a graph showing the change with time in strain of a polarizing plate in the MD direction in the above other examples of the present invention.

### DETAILED DESCRIPTION OF THE INVENTION

In the polarizing plate of the present invention, it is preferable that the optical compensation layer has an Nz coefficient in the range from 1 to 2, more preferably from 1 to 1.6, and still more preferably from 1 to 1.4.

In the polarizing plate of the present invention, it is preferable that the polarizer and the optical compensation layer are laminated via an adhesive layer formed of a water-soluble adhesive containing a polyvinyl alcohol resin.

In the polarizing plate of the present invention, it is preferable that the water-soluble adhesive containing a polyvinyl alcohol resin further contains a metal compound colloid and that the adhesive layer contains metal compound fine particles derived from the metal compound colloid.

In the polarizing plate of the present invention, the transparent protective film is not particularly limited, and may be, for example, a triacetylcellulose (TAC) film.

In the polarizing plate of the present invention, it is preferable that a strain (με) in the TD direction is 700 or less and a strain (με) in the MD direction is 600 or less after the polarizing plate is heat-treated at 50° C.±3° C. for 120 minutes. The strain can be measured by, for example, a method described in examples described later.

In the second liquid crystal panel of the present invention, it is preferable that: a refractive index of the first optical compensation layer has a relationship of nx>ny≧nz; a refractive index of the second optical compensation layer has a relationship of nx=ny>nz; and the transmittance (T₂) of the second polarizing plate is greater than the transmittance (T₁) of the first polarizing plate.

In the second liquid crystal panel of the present invention, it is preferable that the difference (ΔT=T₂−T₁) between the transmittance (T₂) of the second polarizing plate and that the transmittance (T₁) of the first polarizing plate is in a range from 0.1% to 6.0%.

In the second liquid crystal panel of the present invention, it is preferable that the transmittance (T₁) of the first polarizing plate is in the range from 38.3% to 43.3%.

In the second liquid crystal panel of the present invention, it is preferable that the transmittance (T₂) of the second polarizing plate is in the range from, 41.1% to 44.3%.

In the second liquid crystal panel of the present invention, it is preferable that the second optical compensation layer is a retardation film containing at least one thermoplastic resin selected from the group consisting of polyimide resins, cellulose resins, norbornene resins, polycarbonate resins, and polyamide resins.

In the second liquid crystal panel of the present invention, it is preferable that the second optical compensation layer is any one of a retardation layer (B1) containing a polyimide resin, a retardation layer (B2) containing a cellulose resin, and a laminate (C) including the retardation layer (B1) and the retardation layer (B2).

In the first and second liquid crystal panel of the present invention, it is preferable that the liquid crystal cell is a VA mode liquid crystal cell.

Next, the polarizing plate, the liquid crystal panel, and the liquid crystal display of the present invention will be described in detail by way of examples.

[A. Definition and the Like]

In the present invention, the moisture content (%) of the polarizing plate can be calculated, for example, based on the following equation (I) by measuring the weights of the polarizing plate before and after a heat treatment. For example, the moisture content (%) of the polarizing plate can be calculated by the method described in examples described later.

Moisture content(%)={(W0−W1)/W0}×100 (I)

W0: the weight of the polarizing plate before being subjected to a heat treatment

W1: the weight of the polarizing plate after being subjected to the heat treatment

In the present invention, a refractive index “nx” denotes a refractive index in a direction (a slow axis direction) in which a refractive index within a plane of the layer (a transparent protective film, an optical compensation layer, a liquid crystal cell, or the like, hereinafter the same) reaches its maximum. A refractive index “ny” denotes a refractive index in a direction (a fast axis direction) that is orthogonal to the nx direction within the plane of the layer. A refractive index “nz” denotes a refractive index in the thickness direction of the layer, which is orthogonal to each of the nx and ny directions.

In the present invention, a retardation value Re[λ] within a plane of the layer is, for example, an in-plane retardation value at a wavelength λ (nm) at 23° C., calculated based on an equation: Re[λ]=(nx−ny)×d, where d (nm) is the thickness of the layer.

In the present invention, a retardation value (Rth[λ]) in the thickness direction of the layer denotes a retardation value at a wavelength of λ (nm) at 23° C., calculated based on an equation: Rth[λ]=(nx−nz)×d, where d (nm) is the thickness of the layer.

In the present invention, a birefringence (Δn_{xz}[λ]) in the thickness direction of the layer is, for example, a value calculated based on an equation: Δn_{xz}[λ]=Rth[λ]/d, where d (nm) is the thickness of the retardation layer.

In the present invention, an Nz coefficient is, for example, a value calculated based on an equation: Nz coefficient=Rth[λ]/Re[λ]. λ can be set to 590 nm, for instance.

In the present invention, “nx=ny” or “ny=nz” not only means that they are completely the same, but also encompasses the case where they are substantially the same. Therefore, for example, when it is described that nx=ny, it encompasses the case where Re[590] is less than 10 nm.

In the present invention, the term “orthogonal” also encompasses the case of “substantially orthogonal”, which means, for example, the deviation is within the range from 90°±2°, preferably from 90°±1°. Also, in the present invention, the term “parallel” also encompasses the case of “substantially parallel”, which means, for example, the deviation is within the range from 0°±2°, preferably from 0°±1°.

In the present invention, the transmittance (T) of the polarizing plate is a Y value whose luminous factor has been corrected in view of a two-degree visual field (C light source) according to JIS Z 8701 (1982 version).

[B. Polarizing Plate of the Present Invention]

### [B-1. Overall Configuration of the Polarizing Plate of the Present Invention]

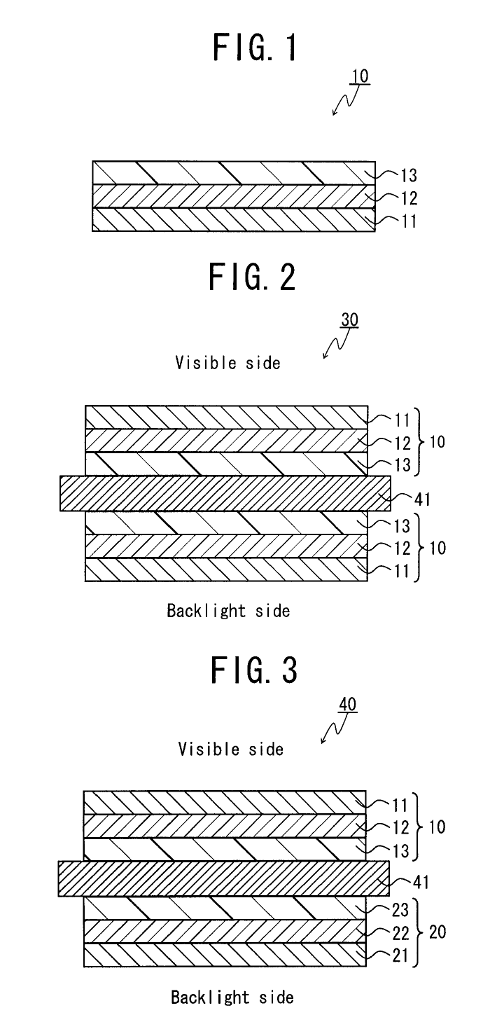

An example of the configuration of the polarizing plate of the present invention is shown in the schematic sectional view of FIG. 1. In FIG. 1, the sizes, proportions, etc. of the respective components are different from the actual sizes, proportions, etc, for the sake of simplicity in illustration. As shown in FIG. 1, this polarizing plate 10 includes a transparent protective film 1, a polarizer 12, and an optical compensation layer 13, which are laminated in this order. The moisture permeability of the transparent protective film 1 is different from that of the optical compensation layer 13. The moisture content of the polarizing plate 10 is not more than 3%. Thus, in the polarizing plate 10, strain caused by the heat when the backlight is on is suppressed. As a result, in the polarizing plate 10, the occurrence of luminance nonuniformity due to the strain is prevented. The moisture content of the polarizing plate preferably is not more than 2.5%, more preferably not more than 2.0%.

Between the respective components (the optical elements) of the polarizing plate, an adhesive layer (not shown) or an optical element (preferably, the one exhibiting isotropy) may be optionally included. The “adhesive layer” refers to a layer that joins the surfaces of adjacent optical elements and integrates them with a practically sufficient adhesion strength within a practically acceptable adhesion time. Examples of the material for forming the adhesive layer include, for example, conventionally known adhesives, pressure-sensitive adhesives, and anchor coating agents. The adhesive layer may have a multilayer structure in which an anchor coating layer is formed on a surface of a substance to be joined and an adhesive layer is formed on the anchor coating layer. Furthermore, the adhesive layer may be a thin layer (also referred to as a hairline) that cannot be recognized with the naked eye.

The overall thickness of the polarizing plate of the present invention is, for example, in the range from 20 to 300 μm. By setting the thickness in the above-described range, it is possible to obtain a polarizing plate having a still higher mechanical strength.

[B-2. Transparent Protective Film]

It is preferable that the transparent protective film is colorless. The in-plane retardation value Re[550] of the transparent protective film is in the range, for example, from 0 to 10 nm, preferably from 0 to 6 nm, and more preferably from 0 to 3 nm. The retardation value Rth[550] in the thickness direction of the transparent protective film is in the range from, for example, 0 to 20 nm, preferably from 0 to 10 nm, more preferably from 0 to 6 nm, and still more preferably from 0 to 3 nm.

The thickness of the transparent protective film is in the range from, for example, 20 to 200 μm, preferably from 30 to 100 μm, and more preferably from 35 to 95 μm.

As the transparent protective film, a cellulose-based film is used, for example. A cellulose-based film used as a general protective film has a large retardation value (Rth) in the thickness direction: in the case of a triacetylcellulose (TAC) film, for example, the retardation value (Rth) in the thickness direction is about 40 nm when the thickness of the film is 40 μm. The cellulose-based film having a large retardation value (Rth) in the thickness direction preferably is subjected to an appropriate treatment for reducing the retardation value (Rth) in the thickness direction.

As the treatment for reducing the retardation value (Rth) in the thickness direction, any appropriate treatment method can be employed. Examples of the treatment method include: a method in which a base made of polyethylene terephthalate (PET), polypropylene, stainless steel, or the like to which a solvent such as cyclopentanone or methyl ethyl ketone has been applied is attached to a generally-used cellulose-based film, the resultant laminate is heat dried (for example, at around 80° C. to 150° C. for about 3 to 10 minutes), and then the base film is peeled off; and a method in which a solution obtained by dissolving a norbornene resin, an acrylic resin, or the like in a solvent such as cyclopentanone or methyl ethyl ketone is applied onto a generally-used cellulose-based film, the cellulose-based film is heat dried (for example, at around 80° C. to 150° C. for about 3 to 10 minutes), and then a film formed of the applied solution is peeled off.

The material for forming the cellulose-based film preferably is an aliphatic-substituted cellulose polymer such as diacetyl cellulose or TAC. TAC, which is used generally, has an acetic acid substitution degree of about 2.8. However, it is possible to control the retardation value (Rth) in the thickness direction to be small preferably by controlling the acetic acid substitution degree to be in the range from 1.8 to 2.7, more preferably by controlling a propionic acid substitution degree to be in the range from 0.1 to 1.

The above-described techniques for controlling the retardation value (Rth) in the thickness direction to be small may be used in combination as appropriate.

Other specific examples of the preferable transparent protective film that can satisfy the above-described optical characteristics (the in-plane retardation value Re[550] and the retardation value Rth[550] in the thickness direction) include acrylic resin films. A preferable acrylic resin film is an acrylic resin film disclosed in JP 2005-314534 A, which contains, as a main component, an acrylic resin (A) containing a glutaric acid anhydride unit represented by the following structural formula (1). By containing the glutaric acid anhydride unit represented by the following structural formula (1), the acrylic resin film can have an improved heat resistance. In the following structural formula (1), R¹ and R² each are a hydrogen atom or an alkyl group having 1 to 5 carbon atoms. R¹ and R² may be identical to or different from each other. It is preferable that R¹ and R² each are a hydrogen atom or a methyl group, more preferably a methyl group.

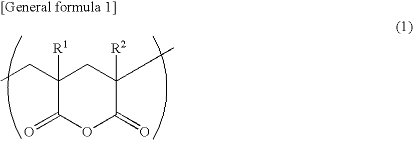

In the acrylic resin (A), the content of the glutaric acid anhydride unit represented by the structural formula (1) preferably is in the range from 20 to 40 wt %, more preferably from 25 to 35 wt %.

The acrylic resin (A) may contain one kind or two or more kinds of any appropriate monomer units, in addition to the glutaric acid anhydride unit represented by the above structural formula (1). Such a monomer unit preferably is a vinyl carboxylic acid alkyl ester unit. In the acrylic resin (A), the content of the vinyl carboxylic acid alkyl ester unit preferably is in the range from 60 to 80 wt %, more preferably from 65 to 75 wt %.

Examples of the vinyl carboxylic acid alkyl ester unit include one represented by the following general formula (2). In the following general formula (2), R³ is a hydrogen atom or an aliphatic or alicyclic hydrocarbon having 1 to 5 carbon atoms, and R⁴ is an aliphatic hydrocarbon having 1 to 5 carbon atoms.

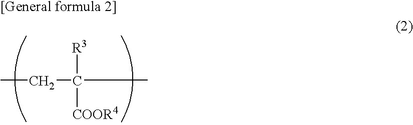

The weight-average molecular weight of the acrylic resin (A) preferably is in the range from 80000 to 150000.

The content of the acrylic resin (A) in the acrylic resin film preferably is in the range from 60 to 90 wt %.

The acrylic resin film may contain one kind or two or more kinds of any appropriate components, in addition to the acrylic resin (A). As such a component, any appropriate component can be employed as long as it does not ruin the effect of the present invention. Examples of the component may include resins other than the acrylic resin (A), UV-absorbers, antioxidants, lubricants, plasticizers, release agents, anti-coloring agents, flame retardants, nucleating agents, antistatic agents, pigments, and colorants.

The transparent protective film may have a surface treatment layer on the side opposite to the polarizer side. As the surface treatment, a suitable treatment can be employed as appropriate depending on the purpose of performing it. Examples of the surface treatment layer include treatment layers for performing a hard-coat treatment, an antistatic treatment, a treatment for preventing reflection (also referred to as an antireflection treatment), and a diffusion treatment (also referred to as an anti-glare treatment). These surface treatments are used for the purpose of preventing the screen from being contaminated or damaged and also preventing the display screen image from being unable to be seen clearly due to reflected glare of a fluorescent lamp in a room or sunlight in the screen. As the surface treatment layer, a layer obtained by fixing a treatment agent for forming the treatment layer on a surface of a base film generally is used. The base film may also serve as the transparent protective film. Moreover, the surface treatment layer may have a multilayer structure in which a hard-coat treatment layer is laminated on an antistatic treatment layer, for example.

As the transparent protective film, a surface-treated commercially available polymer film can be used as it is, for example. Alternatively, it is possible to use the commercially available polymer film after subjecting it to any surface treatment. Examples of a commercially available film that has been subjected to the diffusion treatment (the anti-glare treatment) include “AG150”, “AGS1”, and “AGS2” (all trade names) manufactured by Nitto Denko Corporation. Examples of a commercially available film that has been subjected to the treatment for preventing reflection (the antireflection treatment) include “ARS” and “ARC” (both trade names) manufactured by Nitto Denko Corporation. Examples of a commercially available film that has been subjected to the hard-coat treatment and the antistatic treatment include “KC8UX-HA” (trade name) manufactured by Konica Minolta Opto, Inc. Examples of a commercially available film that has been subjected to the antireflection treatment include “REOLOOK” (trade name) series manufactured by NOF CORPORATION.

[B-3. Polarizer]

The polarizer can be obtained by, for example, stretching a polymer film that contains a polyvinyl alcohol resin containing iodine. The content of the iodine in the polarizer is as described below. Preferably, the polarizer further contains potassium. The content of the potassium is, for example, in the range from 0.2 to 1.0 wt %, preferably from 0.3 to 0.9 wt %, and more preferably from 0.4 to 0.8 wt %. Preferably, the polarizer further contains boron. The content of the boron is, for example, in the range from 0.5 to 3.0 wt %, preferably from 1.0 to 2.8 wt %, and more preferably from 1.5 to 2.6 wt %.

The polyvinyl alcohol resin can be obtained by, for example, saponifying a vinyl ester polymer that is obtained by polymerizing a vinyl ester monomer. The saponification degree of the polyvinyl alcohol resin preferably is in the range from 95.0 to 99.9 mol %. By using the polyvinyl alcohol resin with the saponification degree in the above-described range, it is possible to obtain a polarizer with a higher durability. With regard to the average polymerization degree of the polyvinyl alcohol resin, any suitable value can be selected as appropriate in accordance with the purpose of using the polyvinyl alcohol resin. The average polymerization degree preferably is in the range from 1200 to 3600. The average polymerization degree can be determined according to JIS K 6726 (1994 version), for example.

As a method of obtaining a polymer film containing the polyvinyl alcohol resin, any suitable processing method can be employed. Example of the processing method include the one that is described in [Example 1] of JP 2001-315144 A.

The polymer film containing the polyvinyl alcohol resin preferably contains at least one of a plasticizer and a surfactant. Examples of the plasticizer include polyhydric alcohols such as ethylene glycol and glycerin. Examples of the surfactant include nonionic surfactants. The content of the plasticizer and the surfactant preferably is in the range from 1 to 10 parts by weight with respect to 100 parts by weight of the polyvinyl alcohol resin. The plasticizer and the surfactant enhance the dye-affinity and the stretchability of the polarizer, for example.

As the polymer film containing the polyvinyl alcohol resin, it is possible to use a commercially available film as it is, for example. Examples of the commercially available polymer film containing the polyvinyl alcohol resin include “KURARAY VINYLON FILM” (trade name) manufactured by Kuraray Co., Ltd., “TOHCELLO VINYLON FILM” (trade name) manufactured by Tohcello Co., Ltd., and “NICHIGO VINYLON FILM” (trade name) manufactured by Nippon Synthetic Chemical Industry Co., Ltd.

[B-4. Optical Compensation Layer]

As described above, the optical compensation layer is a retardation film containing at least one resin selected from norbornene resins, polyvinyl acetal resins, polyester resins, polypropylene resins, polycarbonate resins, and acrylic resins.

First, a retardation film containing a norbornene resin will be described. The norbornene resin is characterized in that the absolute value of the photoelastic coefficient (C[λ], where λ can be set to 590 nm, for example) is small. The absolute value (C[590]) of the photoelastic coefficient of the norbornene resin at a wavelength of 590 nm preferably is in the range from 1×10⁻¹² m²/N to 1×10⁻¹¹ m²/N. In the present invention, the “norbornene resin” refers to a (co)polymer obtained by using a norbornene monomer having a norbornene ring as a part or whole of the starting material (a monomer). The term “(co)polymer” means a homopolymer or a copolymer.

As the starting material of the norbornene resin, a norbornene monomer having a norbornene ring (which is a norbornane ring having a double bond) is used. When the norbornene resin is in the form of (co)polymer, the norbornane ring may or may not be present in the constitutional unit. Examples of the norbornene resin having a norbornane ring in the constitutional unit when it is in the form of (co)polymer include tetracyclo[4.4.1^{2,5}.1^{7,10}.0]dec-3-en, 8-methyl tetracyclo[4.4.1^{2,5}.1^{7,10}.0]dec-3-en, and 8-methoxycarbonyl tetracyclo[4.4.1^{2,5}.1^{7,10}.0]dec-3-en. Examples of the norbornene resin not having a norbornane ring in the constitutional unit when it is in the form of (co)polymer include (co)polymers obtained by using a monomer that turns to a 5-membered ring upon cleavage. Examples of the monomer that turns to a 5-membered ring upon cleavage include norbornene, dicyclopentadiene, 5-phenyl norbornene, and derivatives thereof. When the norbornene resin is a copolymer, the alignment state of its molecules is not particularly limited, and the copolymer may be a random copolymer, a block copolymer, or a graft copolymer.

Examples of the norbornene resin include: (a) a resin obtained by hydrogenating a ring-opening (co)polymer of a norbornene monomer; and (b) a resin obtained through addition (co)polymerization of a norbornene monomer. The resin obtained by hydrogenating a ring-opening copolymer of a norbornene monomer includes a resin obtained by hydrogenating a ring-opening copolymer of at least one kind of norbornene monomer with at least one selected from α-olefins, cycloalkenes, and unconjugated dienes. The resin obtained through addition copolymerization of a norbornene monomer includes a resin obtained through addition copolymerization of at least one kind norbornene monomer with at least one selected from α-olefins, cycloalkenes, and unconjugated dienes.

The resin obtained by hydrogenating a ring-opening (co)polymer of a norbornene monomer can be obtained by, for example, obtaining a ring-opening (co)polymer by causing a metathesis reaction of the norbornene monomer or the like and then hydrogenating the ring-opening (co)polymer. Specifically, this can be achieved by a method described in paragraphs [0059] and [0060] of JP 1 (1999)-116780 A, a method described in paragraphs [0035] to [0037] of JP 2001-350017 A, etc., for example. The resin obtained through addition (co)polymerization of a norbornene monomer can be obtained by a method described in Example 1 of JP 61 (1986)-292601 A, for example.

With regard to the weight-average molecular weight (Mw) of the norbornene resin, it is preferable that the measured value obtained by gel permeation chromatography (polystyrene standard) using a tetrahydrofuran solvent is in the range from 20000 to 500000. The glass transition temperature (Tg) of the norbornene resin preferably is in the range from 120° C. to 170° C. With the use of the above-described resin, it is possible to obtain a retardation film with a still higher thermal stability and still higher stretchability. The glass transition temperature (Tg) is a value calculated by a differential scanning calorimetry (DSC) method according to JIS K 7121 (1987 version), for example.

The retardation film containing the norbornene resin is produced by, for example, stretching a polymer film, which has been formed into a sheet-like shape by a solvent casting method or a melt extrusion method, by a longitudinal uniaxial stretching method, a transverse uniaxial stretching method, a longitudinal-transverse simultaneous biaxial stretching method, or a longitudinal-transverse sequential biaxial stretching method. It is preferable that the stretching method is the transverse uniaxial stretching method from the viewpoint of manufacturing efficiency. The temperature at which the polymer film is stretched (the stretching temperature) preferably is in the range from 120° C. to 200° C. The ratio at which the polymer film is stretched (the stretch ratio) preferably is more than 1 and not more than 4 times. The stretching method may be a fixed-end stretching method or a free-end stretching method. According to the fixed-end stretching method, it is possible to produce a retardation film having a relationship of nx>ny>nz.

As the retardation film containing the norbornene resin, it is possible to use a commercially available film as it is, for example. Alternatively, it is possible to use the commercially available film that has been subjected to secondary processing, e.g., at least one of a stretching treatment and a shrinking treatment. Examples of the commercially available retardation film containing the norbornene resin include “ARTON” (trade name) series (ARTON F, ARTON FX, ARTON D) manufactured by JSR Corporation and “ZEONOR” (trade name) series (ZEONOR ZF14, ZEONOR ZF15, ZEONOR ZF16) manufactured by OPTES INC.

Next, a retardation film containing a polyvinyl acetal resin will be described. The polyvinyl acetal resin is not particularly limited. As the polyvinyl acetal resin, it is possible to use, for example, a resin described in the paragraph [0026] of Japanese Patent No. 3984277, which contains a polymer represented by the following general formula (3). By containing a naphthyl group in its molecule structure, the polymer is excellent in transparency, heat resistance, and workability.

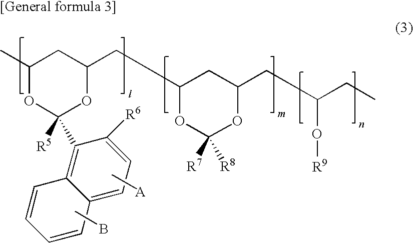

The polymer can be obtained by, for example, causing a condensation reaction of at least two kinds of aldehyde and/or ketone compounds with a polyvinyl alcohol resin. In the polymer represented by the general formula (3), the order in which base units l, m, and n are arranged is not particularly limited, and may be any of alternating, random, and block arrangements. The above-described polymer encompasses a polymer in which the total of the polymerization degrees of the base units l, m, and n is 20 or more and the weight-average molecular weight is high (a so-called high polymer). It also encompasses a low polymer in which the total of the polymerization degrees of the base units l, m, and n is not less than 2 and less than 20 and the weight-average molecular weight is about several thousands (a so-called oligomer).

In the general formula (3), R⁵ and R⁷ each are a hydrogen atom, a halogen atom, a straight-chain or branched-chain alkyl group having 1 to 4 carbon atoms, or a substituted or unsubstituted phenyl group. R⁵ and R⁷ may be identical to or different from each other.

In the general formula (3), A, and B each are a hydrogen atom, a halogen atom, a straight-chain or branched-chain alkyl group having 1 to 4 carbon atoms, a straight-chain or branched-chain alkyl halide group having 1 to 4 carbon atoms, a straight-chain or branched-chain alkoxy group having 1 to 4 carbon atoms, an alkoxycarbonyl group, an acyloxy group, an amino group, an azido group, a nitro group, a cyano group, or a hydroxyl group. R⁶ is a hydrogen atom, a halogen atom, a straight-chain or branched-chain alkyl group having 1 to 4 carbon atoms, a straight-chain or branched-chain alkyl halide group having 1 to 4 carbon atoms, a straight-chain or branched-chain alkoxy group having 1 to 4 carbon atoms, an alkoxycarbonyl group, an acyloxy group, an amino group, an azido group, a nitro group, a cyano group, or a hydroxyl group. R⁶, A, and B may be identical to or different from each other.

In the general formula (3), R⁸ is a hydrogen atom, a straight-chain or branched-chain alkyl group having 1 to 4 carbon atoms, a substituted or unsubstituted cycloalkyl group having 5 to 10 carbon atoms, a substituted or unsubstituted phenyl group, a substituted or unsubstituted naphthyl group, or a substituted or unsubstituted heterocyclic group.

In the general formula (3), R⁹ is a hydrogen atom, a straight-chain or branched-chain alkyl group having 1 to 4 carbon atoms, a benzyl group, a silyl group, a phosphate group, an acyl group, a benzoyl group or a sulfonyl group.

The retardation film containing the polyvinyl acetal resin can be produced by, for example, forming the polyvinyl acetal resin into a sheet-like shape by a compression molding method, a transfer molding method, an injection molding method, an extrusion molding method, a blow molding method, a powder molding method, a FRP molding method, a solvent casting method, or the like so as to obtain a polymer film and then stretching the thus-obtained polymer film by an appropriately selected stretching method under appropriately selected stretching conditions (e.g., a stretching temperature, a stretch ratio, a stretching direction, and the like).

The retardation film used as the optical compensation layer may further contain any suitable additive. Examples of the additive include plasticizers, thermostabilizers, light stabilizers, lubricants, antioxidants, UV absorbers, flame retardants, colorants, antistatic agents, compatibilizers, crosslinking agents, and thickeners. The content of the additive preferably is in the range of more than 0 and not more than 10 parts by weight with respect to 100 parts by weight of the resin as a main component.

The refractive index of the optical compensation layer has a relationship of nx>ny≧nz, for example. That is, the refractive index of the optical compensation layer may have a relationship of nx>ny=nz (positive uniaxiality) or a relationship of nx>ny>nz (negative biaxiality). Preferably, the refractive index of the optical compensation layer has a relationship of nx>ny=nz. The Nz coefficient of the optical compensation layer is as described above.

Re[590] of the optical compensation layer is, for example, at least 10 nm, preferably in the range from 50 to 200 nm. When the refractive index of the optical compensation layer has a relationship of nx>ny=nz, Re[590] is in the range, for example, from 90 to 190 nm, preferably from 110 to 170 nm. When the refractive index of the optical compensation layer has a relationship of nx>ny>nz (negative biaxiality), Re[590] is in the range, for example, from 70 to 170 nm, preferably from 90 to 150 nm.

When the refractive index of the optical compensation layer has a relationship of nx>ny=nz, Re[590] and Rth[590] are substantially the same. In this case, it is preferable that the optical compensation layer satisfies the equation: |Rth[590]−Re[590]|<10 nm.

When the refractive index of the optical compensation layer has a relationship of nx>ny>nz, Rth[590] is greater than Re[590]. In this case, the difference (Rth[590]−Re[590]) between Rth[590] and Re[590] is in the range, for example, from 10 to 100 nm, preferably from 20 to 80 nm.

The transmittance (T[590]) of the optical compensation layer at a wavelength of 590 nm preferably is at least 90%.

The optical compensation layer may be a single layer or may be a laminate including a plurality of layers. The thickness of the optical compensation layer is, for example, in the range from 0.5 to 200 μm.

[B-5. Lamination of Polarizer and Optical Compensation Layer]

Preferably, the polarizer and the optical compensation layer are laminated via an adhesive layer. In the example shown in FIG. 1, a polarizer 12 and an optical compensation layer 13 are laminated via an adhesive layer.

The surface of the optical compensation layer to be adhered to the polarizer preferably is subjected to an adhesion-improving treatment. It is preferable that the adhesion-improving treatment is a treatment of coating a resin material onto the surface. As the resin material, silicon resins, urethane resins, and acrylic resins are preferable. By performing the adhesion-improving treatment, an adhesion-improving layer is formed on the adhesion surface. The thickness of the adhesion-improving layer preferably is in the range from 5 to 100 nm, more preferably from 10 to 80 nm.

The adhesive layer may be provided on either the polarizer side or the optical compensation layer side, or on both the polarizer side and the optical compensation layer side.

When the adhesive layer is a pressure-sensitive adhesive layer formed of a pressure-sensitive adhesive, it is possible to employ any suitable pressure-sensitive adhesive as the pressure-sensitive adhesive. Specifically, examples of the pressure-sensitive adhesive include solvent-type pressure-sensitive adhesives, nonaqueous emulsion-type pressure-sensitive adhesives, aqueous pressure-sensitive adhesives, and hot-melt pressure-sensitive adhesive. Among these, a solvent-type pressure-sensitive adhesive containing an acrylic polymer as a base polymer preferably is used. This is because the pressure-sensitive adhesive layer formed of such a solvent-type pressure-sensitive adhesives exhibits appropriate sticking characteristics (e.g., wettability, cohesiveness, and adhesiveness) with respect to the polarizer and the optical compensation layer and is excellent in optical transparency, weather resistance, and heat resistance.

The thickness of the pressure-sensitive adhesive layer can be set as appropriate depending on the purpose of using the layer, adhesion strength, etc. Specifically, the thickness of the pressure-sensitive adhesive layer preferably is in the range from 1 to 100 μm, more preferably from 3 to 50 μm, still more preferably from 5 to 30 μm, and particularly preferably 10 to 25 μm.

The adhesive layer may be formed by, for example, coating a coating solution containing an adhesive in a predetermined proportion onto a surface of at least one of the optical compensation layer and the polarizer and then drying it. As a method of preparing the coating solution, any suitable method can be employed. As the coating solution, for example, a commercially available solution or dispersion may be used, a mixture obtained by further adding a solvent to a commercially available solution or dispersion may be used, or a mixture obtained by dissolving or dispersing a solid in a solvent of various types may be used.

As the adhesive, an adhesive having any suitable property, form, and adhesion mechanism can be used depending on the purpose of using it. Specifically, examples of the adhesive include water-soluble adhesives, emulsion-type adhesives, latex-type adhesives, mastic adhesives, multilayer adhesives, paste-form adhesives, foaming-type adhesives, supported film adhesives, thermoplastic adhesives, thermofusible adhesives, heat solidified-type adhesives, hot-melt adhesives, heat activated-type adhesives, heat-sealing adhesives, thermosetting adhesives, contact-type adhesives, pressure-sensitive adhesives, polymerization-type adhesives, solvent-type adhesives, and solvent activated-type adhesives. Among these, water-soluble adhesives are preferable, because they are excellent in transparency, adhesiveness, and operability, and can impart excellent quality and cost efficiency to a product.

The water-soluble adhesive may contain at least one of a water-soluble naturally-occurring polymer and a water-soluble synthetic polymer, for example. Examples of the naturally-occurring polymer include proteins and starches. Examples of the synthetic polymer include resole resins, urea resins, melamine resins, polyethylene oxide, polyacrylamide, polyvinyl pyrrolidone, acrylic ester, methacrylic ester, and polyvinyl alcohol resins. Among these, a water-soluble adhesive that contains a polyvinyl alcohol resin is used preferably, and a water-soluble adhesive that contains a modified polyvinyl alcohol resin containing an acetoacetyl group (an acetoacetyl group-containing polyvinyl alcohol resin) is used more preferably. That is, as described above, in the polarizing plate of the present invention, it is preferable that the adhesive layer contains a water-soluble adhesive containing a polyvinyl alcohol resin. This is because such an adhesive achieves particularly excellent adhesiveness to the polarizer and also achieves excellent adhesiveness to the optical compensation layer. Examples of the acetoacetyl group-containing polyvinyl alcohol resin include “GOHSENOL Z” (trade name) series manufactured by Nippon Synthetic Chemical Industry Co., Ltd., “GOHSENOL NH” (trade name) series manufactured by the same, and “GOHSEFIMER Z” (trade name) series manufactured by the same.

Examples of the polyvinyl alcohol resin include a saponified product of polyvinyl acetate, derivatives of the saponified product, saponified products of copolymers of monomers that can copolymerize with vinyl acetate, and modified polyvinyl alcohols obtained through acetalization, urethanization, etherification, grafting, phosphorylation, etc. of polyvinyl alcohols. Examples of the monomer include unsaturated carboxylic acids such as maleic acid, maleic anhydride, fumaric acid, crotonic acid, itaconic acid, acrylic acid, and methacrylic acid, and esters thereof, α-olefins such as ethylene and propylene, allylsulfonate, methallylsulfonate, sodium allylsulfonate, sodium methallylsulfonate, sodium sulfonate, sodium sulfonate monoalkyl malate, sodium disulfonate alkyl malate, N-methylol acrylamide, acrylamide alkyl sulfonate alkali salt, N-vinyl pyrrolidone, and derivatives of N-vinyl pyrrolidone. These resins may be used alone or in combination of at least two kinds thereof.

The average polymerization degree of the polyvinyl alcohol resin preferably is in the range from 100 to 5000, more preferably from 1000 to 4000 from the viewpoint of adhesiveness. The average saponification degree of the polyvinyl alcohol resin preferably is in the range from 85 to 100 mol %, more preferably from 90 to 100 mol % from the viewpoint of adhesiveness.

The acetoacetyl group-containing polyvinyl alcohol resin can be obtained by reacting a polyvinyl alcohol resin with diketene by any method, for example. Specifically, this can be achieved by: adding diketene to a dispersion obtained by dispersing the polyvinyl alcohol resin in a solvent such as acetic acid; by adding diketene to a solution obtained by dissolving the polyvinyl alcohol resin in a solvent such as dimethylformamide or dioxane; or by bringing diketene gas or liquid diketene into contact with the polyvinyl alcohol resin directly, for example.

The modification degree of the acetoacetyl group-containing polyvinyl alcohol resin with an acetoacetyl group is at least 0.1 mol %, for instance. By setting the acetoacetyl group modification degree in above-described range, it is possible to obtain a polarizing plate with still higher water resistance. The acetoacetyl group modification degree preferably is in the range from 0.1 to 40 mol %, more preferably from 1 to 20 mol %, and still more preferably from 2 to 7 mol %. The acetoacetyl group modification degree is a value measured by nuclear magnetic resonance (NMR), for example.

The water-soluble adhesive containing the polyvinyl alcohol resin may further contain a crosslinking agent. This is because this can improve the water resistance still further. As the crosslinking agent, any suitable crosslinking agent can be employed. Preferably, the crosslinking agent is a compound having at least two functional groups reactive with the polyvinyl alcohol resin. Examples of the crosslinking agent include: alkylene diamines having an alkylene group and two amino groups, such as ethylene diamine, triethylene diamine, and hexamethylene diamine; isocyanates such as tolylene diisocyanate, hydrogenated tolylene diisocyanate, trimethylolpropane tolylene diisocyanate adducts, triphenylmethane triisocyanate, methylene bis(4-phenyl)methane triisocyanate, isophorone diisocyanate, and ketoxime-blocked products or phenol-blocked products thereof; epoxies such as ethylene glycol diglycidyl ether, polyethylene glycol diglycidyl ether, glycerin diglycidyl ether, glycerin tridiglycidyl ether, 1,6-hexane diol diglycidyl ether, trimethylolpropane tridiglycidyl ether, diglycidyl aniline, and diglycidylamine; monoaldehydes such as formaldehyde, acetaldehyde, propionaldehyde, and butylaldehyde; dialdehydes such as glyoxal, malondialdehyde, succindialdehyde, glutardialdehyde, maleindialdehyde, and phthaldialdehyde; amino-formaldehyde resins such as methylol urea, methylol melamine, alkylated methylol urea, alkylated methylolated melamine, acetoguanamine, and condensation products of benzoguanamine with formaldehyde; salts of divalent metals or trivalent metals such as sodium, potassium, magnesium, calcium, aluminum, iron, and nickel, and oxides thereof. Among these, amino-formaldehyde resins and dialdehydes are preferable. As the amino-formaldehyde resins, compounds having a methylol group are preferable. As the dialdehyde, glyoxal is preferable. Among the above-noted materials, compounds having a methylol group are preferable, and methylol melamine is particularly preferable. Examples of the aldehyde compound include “GLYOXAL” (trade name) available from Nippon Synthetic Chemical Industry Co., Ltd. and “SEQUAREZ 755” (trade name) available from OMNOVA. Examples of the amine compound include “META-XYLENEDIAMINE” (trade name) available from Mitsubishi Gas Chemical Co., Inc. Examples of the methylol compound include “WATERSOL” (trade name) series available from Dainippon Ink and Chemicals, Inc.

The amount of the crosslinking agent to be blended is, for example, is in the range from 1 to 60 parts by weight with respect to 100 parts by weight of the polyvinyl alcohol resin (preferably, the acetoacetyl group-containing polyvinyl alcohol resin). By setting the blended amount in the above-described range, it is possible to form an adhesive layer that is excellent in transparency, adhesiveness, and water resistance. The upper limit of the blended amount preferably is 50 parts by weight, more preferably 30 parts by weight, still more preferably 15 parts by weight, particularly preferably 10 parts by weight, and most preferably 7 parts by weight. The lower limit of the blended amount preferably is 5 parts by weight, more preferably 10 parts by weight, and still more preferably 20 parts by weight. Note here that, by using a metal compound colloid that will be described later in combination, it is possible to further improve the stability in the case where the blended amount of the crosslinking agent is large.

It is preferable that the water-soluble adhesive containing the polyvinyl alcohol resin further contains a metal compound colloid. This is because this can prevent the generation of “knicks”, which are defective local irregularities formed at the interface between the polarizer and the optical compensation layer. The presence or absence of the knicks can be checked by a method described later in the examples, for instance.

As described above, the polarizing plate of the present invention can be produced by, for example, laminating respective components with an adhesive. However, in a method for producing the polarizing plate of the present invention, it is preferable to use the water-soluble adhesive containing the above-described polyvinyl alcohol resin and metal compound colloid for the lamination of the polarizer and the optical compensation layer.

Furthermore, in this respect, in the polarizing plate of the present invention, it is preferable that the polarizer and the optical compensation layer are laminated using the water-soluble adhesive containing the polyvinyl alcohol resin and the metal compound colloid.

Still further, in the polarizing plate of the present invention, it is preferable that the polarizer and the optical compensation layer are laminated via an adhesive layer formed of the water-soluble adhesive containing the polyvinyl alcohol resin and the metal compound colloid and that the adhesive layer contains metal compound fine particles derived from the metal compound colloid.

The metal compound colloid may be made up of, for example, metal compound fine particles dispersed in a dispersion medium, and may be stabilized electrostatically owing to mutual repulsion of the same type of electric charge of the fine particles so that it remains stabile permanently. The average particle diameter of the fine particles forming the metal compound is not particularly limited, and preferably is in the range from 1 to 100 nm, more preferably from 1 to 50 nm. This is because this allows the fine particles to be dispersed uniformly in the adhesive layer, whereby the formation of knicks can be prevented more favorably while maintaining the adhesiveness.

As the metal compound, any suitable compound can be employed. Examples of the metal compound include metal oxides such as alumina, silica, zirconia, and titania, metal salts such as aluminum silicate, calcium carbonate, magnesium silicate, zinc carbonate, barium carbonate, and calcium phosphate, and minerals such as cerite, talc, clay, and kaoline. Among these, alumina is preferable.

The metal compound colloid is present in the state of a colloid solution in which the metal compound is dispersed in a dispersion medium, for example. Examples of the dispersion medium include water and alcohols. The solid content in the colloid solution is in the range from 1 to 50 wt %, for example. The colloid solution may contain an acid such as nitric acid, hydrochloric acid, and acetic acid as a stabilizer.

The blended amount of the metal compound colloid (the solid) preferably not more than 200 parts by weight with respect to 100 parts by weight of the polyvinyl alcohol resin. By setting the blended amount in the above-described range, the formation of knicks can be prevented more favorably while maintaining the adhesiveness. It is more preferable that the blended amount is in the range from 10 to 200 parts by weight, still more preferably from 20 to 175 parts by weight, and particularly preferably from 30 to 150 parts by weight.

As a method of preparing the adhesive, any suitable method can be employed. For example, in the case of the adhesive containing the metal compound colloid, the method can be such that the polyvinyl alcohol resin and the crosslinking agent are mixed together beforehand, the concentration of the mixture is adjusted to a suitable value, and then the metal compound colloid is blended into the mixture, for example. Also, it is possible to mix the polyvinyl alcohol resin and the metal compound colloid and then add the crosslinking agent to the mixture considering the time when it is used, etc.

The resin concentration in the adhesive preferably is in the range from 0.1 to 15 wt %, more preferably from 0.5 to 10 wt %, from the viewpoint of the coatability, the stability when being left, etc.

The pH of the adhesive preferably is in the range from 2 to 6, more preferably from 2.5 to 5, still more preferably from 3 to 5, and particularly preferably from 3.5 to 4.5. Generally, the surface charge of the metal compound colloid can be controlled by adjusting the pH of the adhesive. The surface charge preferably is positive charge. When the surface charge is positive charge, it is possible to prevent the formation of knicks more favorably, for example.

The total solid content in the adhesive varies depending on the solubility, coating viscosity, and wettability of the adhesive, the desired thickness of the adhesive layer, etc. The total solid content preferably is in the range from 2 to 100 parts by weight with respect to 100 parts by weight of the solvent. By setting the total solid concentration in the above-described range, it is possible to obtain an adhesive layer with still higher surface uniformity. It is more preferable that the solid content is in the range from 10 to 50 parts by weight, still more preferably from 20 to 40 parts by weight.

The viscosity of the adhesive is not particularly limited, but preferably is in the range from 1 to 50 mPa·s when measured at a shear rate of 1000(1/s) at 23° C. By setting the viscosity of the adhesive in the above-described range, it is possible to obtain an adhesive layer with still higher surface uniformity. It is more preferable that the viscosity of the adhesive is in the range from 2 to 30 mPa·s, still more preferably from 4 to 20 mPa·s.

The glass transition temperature (Tg) of the adhesive is not particularly limited, and preferably is in the range from 20° C. to 120° C., more preferably from 40° C. to 100° C., and still more preferably from 50° C. to 90° C. The glass transition temperature can be measured by a differential scanning calorimetry (DSC) measurement according to JIS K 7121 (1987 version), for example.

The adhesive may further contain a coupling agent such as a silane coupling agent or a titanium coupling agent, a tackifier of various types, an UV absorber, an antioxidant, a stabilizer such as a stabilizer for imparting heat resistance or a stabilizer for imparting hydrolysis resistance.

As a method of coating the adhesive, any suitable method can be employed. Examples of the coating method include spin coating, roller coating, flow coating, dip coating, and bar coating.

The thickness of the adhesive layer is not particularly limited, and preferably is in the range from 0.01 to 0.15 μm. By setting the thickness of the adhesive layer in the above-described range, it is possible to obtain a polarizing plate with excellent durability, in which peeling or lifting of the polarizer does not occur even when subjected to a high temperature and high humidity environment. It is more preferable that the thickness of the adhesive layer is in the range from 0.02 to 0.12 μm, still more preferably from 0.03 to 0.09 μm.

[C. First Liquid Crystal Panel]

### [C-1. Overall Configuration of First Liquid Crystal Panel]

As described above, the first liquid crystal panel of the present invention includes a liquid crystal cell and a polarizing plate, and the polarizing plate is the polarizing plate of the present invention. The polarizing plate is arranged on at least one side of the liquid crystal cell with the optical compensation layer being on the liquid crystal cell side. An example of the configuration of the first liquid crystal panel of the present invention is shown in the schematic sectional view of FIG. 2. In FIG. 2, components same as those in FIG. 1 are given the same reference numerals. As shown in FIG. 2, in this first liquid crystal panel 30, the polarizing plates 10 of the present invention are arranged on both the visible side (the upper side in FIG. 2) and the backlight side (the lower side in FIG. 2) of the liquid crystal cell 41 with each of the optical compensation layers 13 being on the liquid crystal cell 41 side. In the first liquid crystal panel of this example, the polarizing plates of the present invention are arranged on both the visible side and the backlight side of the liquid crystal cell. It is to be noted, however, the present invention is not limited thereto. In the first liquid crystal panel of the present invention, the polarizing plate of the present invention may be arranged at least one of the visible side and the backlight side of the liquid crystal cell.

[C-2. Liquid Crystal Cell]

As the liquid crystal cell, an active-matrix type liquid crystal cell using a thin film transistor can be used, for example. Furthermore, as the liquid crystal cell, a simple-matrix type liquid crystal cell as used in a super-twisted nematic liquid crystal display or the like also can be used.

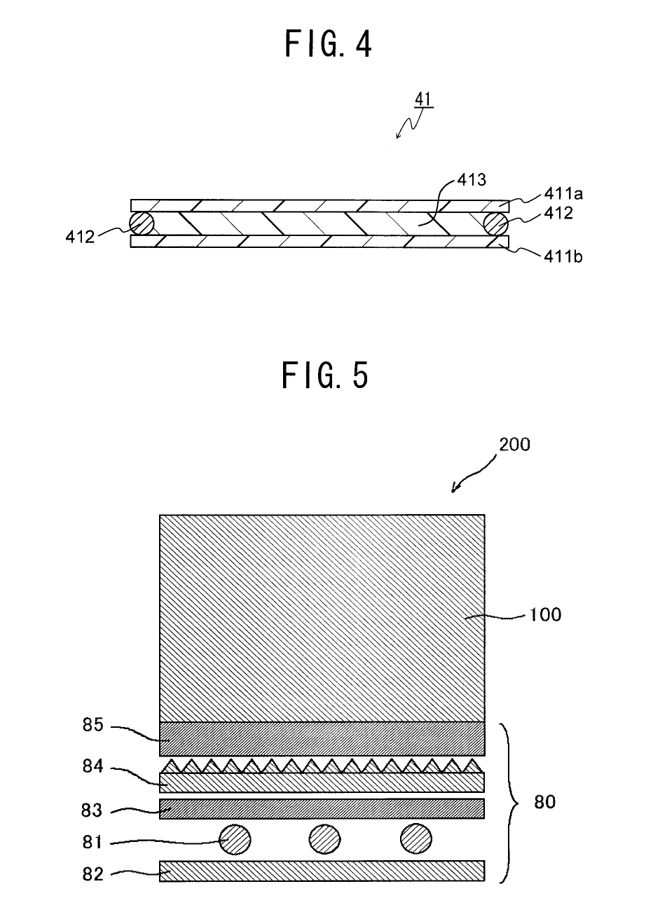

Generally, the liquid crystal cell is configured so that a liquid crystal layer is held between a pair of substrates. FIG. 4 shows an example of the configuration of a liquid crystal cell. As shown in FIG. 4, in a liquid crystal cell 41 of the present example, spacers 412 are arranged between a pair of substrates 411a and 411b to form a space, and a liquid crystal layer 413 is held in this space. Although not shown in the drawing, for example, one substrate (an active matrix substrate) included in the pair of substrates is provided with a switching element (e.g., a TFT) for controlling the electro-optical characteristics of the liquid crystal and a scanning line for supplying gate signals and a signal line for transmitting source signals to this active element. The other substrate included in the pair of substrates is provided with, for example, a color filter.

The color filter may be provided in the active matrix substrate. The color filter may be omitted when the liquid crystal display includes light sources of three colors, namely, RGB (the liquid crystal display may include light sources for more than three colors) as illuminating means as in the case of a field sequential system, for example. The distance between the pair of substrates (i.e., the cell gap) is controlled by a spacer, for example. The cell gap is in the range from 1.0 to 7.0 μm, for example. On the side of each substrate that is in contact with the liquid crystal layer, an alignment film formed of, e.g., polyimide is provided. The alignment film may be omitted when initial alignment of the liquid crystal molecules is controlled by utilizing a fringe electric field generated by a patterned transparent substrate, for example.

It is preferable that the refractive index of the liquid crystal cell has the relationship of nz>nx=ny. Examples of the liquid crystal cell with a refractive index having the relationship of nz>nx=ny include, according to the classification based on the driving mode of the liquid crystal cell, liquid crystal cells of vertical alignment (VA) mode, twisted nematic (TN) mode, vertical-aligned electrically controlled birefringence (ECB) mode, and optically compensated birefringence (OCB) mode. In the present invention, it is preferable that the driving mode of the liquid crystal cell is the VA mode.

Rth[590] of the liquid crystal cell in the absence of an electric field preferably is in the range from −500 to −200 nm, more preferably from −400 to −200 nm. Rth[590] is set as appropriate by adjusting the birefringence of the liquid crystal molecules and the cell gap, for example.

In the VA mode liquid crystal cell, liquid crystal molecules that are in homeotropic alignment are caused to respond to an electric field that is normal to the substrate by utilizing a voltage control birefringence effect in the absence of an electric field. Specifically, as described in, e.g., JP 62 (1987)-210423 A and JP 4 (1992)-153621 A, in the case of a normally black-type liquid crystal cell, liquid crystal molecules are aligned in the normal direction with respect to the substrate in the absence of an electric field. Thus, black display can be obtained by causing the alignments in the polarizing plates provided on upper and lower sides to be orthogonal to each other. On the other hand, in the presence of an electric field, the liquid crystal molecules operate so as to incline toward 45° direction with respect to the absorption axis of the polarizing plate. Thus, the transmittance becomes greater, so that white display can be obtained.

The VA mode liquid crystal cell may have a multi-domain structure by forming a slit in an electrode or by using a base having a projection on its surface, as described in JP 1 (1999)-258605 A, for example. Examples of such a liquid crystal cell include “ASV (ADVANCED SUPER VIEW) mode” (trade name) manufactured by Sharp Corporation, “CPA (CONTINUOUS PINWHEEL ALIGNMENT) mode” (trade name) manufactured by Sharp Corporation, “MVA (MULTI-DOMAIN VERTICAL ALIGNMENT) mode” (trade name) manufactured by Fujitsu Ltd., “PVA (PATTERNED VERTICAL ALIGNMENT) mode” (trade name) manufactured by Samsung Electronics, “EVA (ENHANCED VERTICAL ALIGNMENT) mode” (trade name) manufactured by Samsung Electronics, and “SURVIVAL (SUPER RANGED VIEWING VERTICAL ALIGNMENT) mode” (trade name) manufactured by Sanyo Electric Co., Ltd.

As the liquid crystal cell, it is possible to use a liquid crystal cell equipped in a commercially available liquid crystal display as it is, for example. Examples of a commercially available liquid crystal display including the VA mode liquid crystal cell include liquid crystal televisions “AQUOS” (trade name) series manufactured by Sharp Corporation, liquid crystal televisions “BRAVIA” (trade name) series manufactured by Sony Corp., a 32V-type wide-screen liquid crystal television “LN32R51B” (trade name) manufactured by SAMSUNG, a liquid crystal television “FORIS SC26XD1” (trade name) manufactured by Eizo Nanao Corp., and a liquid crystal television “T460HW01” (trade name) manufactured by AU Optronics.

[D. Second Liquid Crystal Panel]

### [D-1. Overall Configuration of Second Liquid Crystal Panel]

An example of the configuration of the second liquid crystal panel of the present invention is shown in the schematic sectional view of FIG. 3. In FIG. 3, components same as those in FIG. 1 are given the same reference numerals. As shown in FIG. 3, this second liquid crystal panel 40 includes a first polarizing plate 10, a second polarizing plate 20, and a liquid crystal cell 41 as main components. The first polarizing plate 10 is the polarizing plate 10 of the present invention. In the first polarizing plate 10, the transparent protective film 1 is a first transparent protective film 1, and the polarizer 12 is a first polarizer 12, and the optical compensation layer 13 is a first optical compensation layer 13. The second polarizing plate 20 includes a second transparent protective film 21, a second polarizer 22, and a second optical compensation layer 23, which are laminated in this order. The first polarizing plate 10 is arranged on the visible side (the upper side in FIG. 3) of the liquid crystal cell 41 with the first optical compensation layer 13 being on the liquid crystal cell 41 side. The second polarizing plate 20 is arranged on the backlight side (the lower side in FIG. 3) of the liquid crystal cell 41 with the second optical compensation layer 23 being on the liquid crystal cell 41 side.

As described above, in the second liquid crystal panel, it is preferable that: the refractive index of the first optical compensation layer has a relationship of nx>ny≧nz; the refractive index of the second optical compensation layer has a relationship of nx=ny>nz; and the transmittance (T₂) of the second polarizing plate is greater than the transmittance (T₁) of the first polarizing plate. With this configuration, it is possible obtain a liquid crystal panel having a contrast ratio in the front direction much higher than those of conventional liquid crystal panels (typically, liquid crystal panels in which two polarizing plates arranged on respective sides of a liquid crystal cell have the same transmittance).

As described above, in the second liquid crystal panel, it is preferable that the difference (ΔT=T₂−T₁) between the transmittance (T₂) of the second polarizing plate and that the transmittance (T₁) of the first polarizing plate is in the range from 0.1% to 6.0%. By using two polarizing plates having the transmittance difference in the above-described range, it is possible to obtain a liquid crystal panel having a still higher front contrast ratio. The difference (ΔT=T₂−T₁) is more preferably in the range from 0.1% to 5.0%, still more preferably from 0.2% to 4.5%, and particularly preferably from 0.3% to 4.0%.

[D-2. Second Transparent Protective Film]

The second transparent protective film is the same as the above-described transparent protective film (the first transparent protective film).

[D-3. Second Polarizer]

The second polarizer is the same as the above-described polarizer (the first polarizer) except for the following points.

The iodine content (I₁) in the first polarizer and the iodine content (I₂) in the second polarizer preferably has the relationship of I₁>I₂. The difference (ΔI=I₁−I₂) between the iodine content (I₁) in the first polarizer and the iodine content (I₂) in the second polarizer preferably is in the range from 0.1 to 2.6 wt %. By setting the relationship of the iodine contents of the respective polarizers in the above-described range, it is possible to obtain a polarizing plate in which the relationship between the transmittances is in a more preferable range. As a result, it is possible to obtain a liquid crystal panel having a still higher contrast ratio in the front direction. It is more preferable that the difference (ΔI=I₁−I₂) is in the range from 0.1 to 2.0 wt %, still more preferably from 0.1 to 1.4 wt %, and particularly preferably, from 0.15 to 1.2 wt %.

Preferably, the iodine content in each of the first polarizer and the second polarizer is in the range from 1.8 to 5.0 wt %. By setting the iodine content of each of the polarizer in the above-described range, it is possible to obtain a polarizing plate whose transmittance is in a more preferable range. As a result, it is possible to obtain a liquid crystal panel having a still higher contrast ratio in the front direction. More preferably, the iodine content in each of the first polarizer and the second polarizer is in the range from 2.0 to 4.0 wt %. The iodine content in the first polarizer preferably is in the range from 2.3 to 5.0 wt %, more preferably from 2.5 to 4.5 wt %, and still more preferably from 2.5 to 4.0 wt %. The iodine content in the second polarizer preferably is in the range from 1.8 to 3.5 wt %, more preferably from 1.9 to 3.2 wt %.

[D-4. Second Optical Compensation Layer]

The refractive index of the second optical compensation layer has a relationship of nx=ny>nz (negative uniaxiality). The second optical compensation layer may be a single layer or may be a laminate including a plurality of layers. The thickness of the second optical compensation layer preferably is in the range from 0.5 to 200 μm. The transmittance (T[590]) of the second optical compensation layer at a wavelength of 590 nm preferably is at least 90%.

Re[590] of the second optical compensation layer is, for example, less than 10 nm, preferably 5 nm or less, more preferably 3 nm or less.

Rth[590] of the second optical compensation layer can be set as appropriate depending on the retardation value in the thickness direction of the liquid crystal cell, etc., for example. For example, Rth[590] is in the range from 100 to 400 nm, preferably from 120 to 350 nm, and more preferably from 150 to 300 nm.

As the material of the second optical compensation layer, any suitable material can be employed as long as the refractive index thereof has a relationship of nx=ny>nz (negative uniaxiality). As the material, it is possible to employ: poly(4,4′-hexafluoroisopropylidene-bisphenol)terephthalate-co-isophthalate; poly(4,4′-hexahydro-4,7-methanoindan-5-ylidene-bisphenol)terephthalate; poly(4,4′-isopropylidene-2,2′,6,6′-tetrachlorobisphenol)terephthalate-co-isophthalate; poly(4,4′-hexafluoroisopropylidene)-bisphenol-co-(2-norbornylidene)-bisphenol terephthalate; poly(4,4′-hexahydro-4,7-methanoindene-5-ylidene)-bisphenol-co-(4,4′-isopropylidene-2,2′,6,6′-tetrabromo)-bisphenol terephthalate; poly(4,4′-isopropylidene-bisphenol-co-4,4′-(2-norbornylidene)bisphenol) terephthalate-co-isophthalate; and copolymers thereof. They may be used alone or in combination of at least two kinds thereof.

As the second optical compensation layer, it is possible to use, for example, a retardation film containing a thermoplastic resin such as a polyimide resin, a cellulose resin, a norbornene resin, a polycarbonate resin, or a polyamide resin. Such a retardation film preferably contains 60 to 100 parts by weight of the thermoplastic resin with respect to 100 parts by weight of the total solid.

Preferably, the second retardation layer is any one of a retardation film (B1) containing a polyimide resin, a retardation film (B2) containing a cellulose resin, and a laminate (C) of the retardation film (B1) and the retardation film (B2). It is preferable that the laminate (C) is obtained by joining the retardation film (B1) to the retardation film (B2) via an adhesive layer or by forming the retardation film (B1) directly on the surface of the retardation film (B2) by welding or the like.

[Polyimide Resin]

When the polyimide resin is formed into a sheet-like shape by a solvent casting method, molecules are apt to align spontaneously during the evaporating process of the solvent, so that the retardation film with a refractive index having a relationship of nx=ny>nz (negative uniaxiality) can be made very thin. The thickness of the retardation film (B1) containing the polyimide resin preferably is in the range from 0.5 to 10 μm, more preferably from 1 to 5 μm. The birefringence (Δn_{xz[}590]) of the retardation film (B1) in the thickness direction preferably is in the range from 0.01 to 0.12, more preferably from 0.02 to 0.08. Such a polyimide resin can be obtained by the method described in U.S. Pat. No. 5,344,916, for example.

Preferably, the polyimide resin has at least one of a hexafluoroisopropylidene group and a trifluoromethyl group. More preferably, the polyimide resin has at least a group represented by the following general formula (4) or a group represented by the following general formula (5). The polyimide resin containing any of these groups exhibits excellent solubility in a general-purpose solvent, and thus can be formed into a film by a solvent casting method. Furthermore, it is possible to form a thin layer of the polyimide resin even on a base with poor solvent resistance, such as a TAC film, without corroding the surface of the base too much.

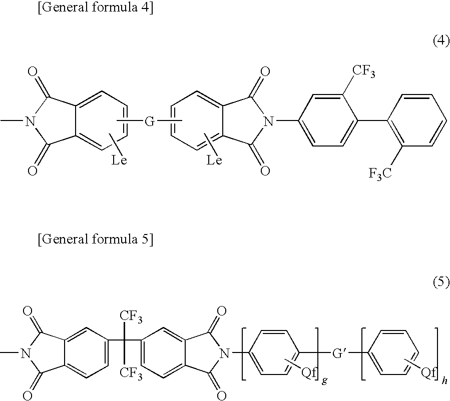

In the above general formulae (4) and (5), G and G′ each are a group selected from the group consisting of a covalent bond, a CH₂ group, a C(CH₃)₂ group, a C(CF₃)₂ group, a C(CX₃)₂ group (where X is halogen), a CO group, an O atom, an S atom, an SO₂ group, an Si(CH₂CH₃)₂ group, and an N(CH₃) group. In the polyimide resin having plural groups represented by the general formula (4), plural Gs in the respective groups may be identical to or different from each other. In the polyimide resin having plural groups represented by the general formula (5), plural G′ s in the respective groups may be identical to or different from each other.

In the above general formula (4), L is a substituent, and e indicates the number of substitutions therein. L is, for example, halogen, an alkyl group having 1 to 3 carbon atoms, an alkyl halide group having 1 to 3 carbon atoms, a phenyl group, or a substituted phenyl group. When there are plural Ls, they may be identical to or different from each other. Furthermore, e is an integer from 0 to 3.

In the above general formula (5), Q is a substituent, and f indicates the number of substitutions therein. Q may be, for example, at least one kind of atom or group selected from the group consisting of hydrogen, halogen, an alkyl group, a substituted alkyl group, a nitro group, a cyano group, a thioalkyl group, an alkoxy group, an aryl group, a substituted aryl group, an alkyl ester group, and a substituted alkyl ester group. When there are plural Qs, they may be identical to or different from each other. Furthermore, f is an integer from 0 to 4, and g and h each are an integer from 1 to 3.

The polyimide resin can be obtained through a reaction between tetracarboxylic dianhydride and diamine, for example. The repeating unit of the general formula (4) can be obtained by, for example, using 2,2′-bis(trifluoromethyl)-4,4′-diaminobiphenyl as diamine and reacting this diamine with tetracarboxylic dianhydride having at least two aromatic rings. The repeating unit of the general formula (5) can be obtained by, for example, using 2,2-bis(3,4-dicarboxyphenyl)hexafluoropropane dianhydride as tetracarboxylic dianhydride and reacting this tetracarboxylic dianhydride with diamine having at least two aromatic rings. The reaction may be chemical imidization that proceeds in two stages or may be thermal imidization that proceeds in a single stage, for example.

As the tetracarboxylic dianhydride, any suitable tetracarboxylic dianhydride can be selected. Examples of the tetracarboxylic dianhydride include:
2,2-bis(3,4-dicarboxyphenyl)hexafluoropropane dianhydride;
3,3′,4,4′-benzophenone tetracarboxylic dianhydride;
2,3,3′,4-benzophenone tetracarboxylic dianhydride;
2,2′,3,3′-benzophenone tetracarboxylic dianhydride;
2,2′-dibromo-4,4′,5,5′-biphenyl tetracarboxylic dianhydride;
2,2′-bis(trifluoromethyl)-4,4′,5,5′-biphenyl tetracarboxylic dianhydride;
3,3′,4,4′-biphenyl tetracarboxylic dianhydride;
4,4′-bis(3,4-dicarboxyphenyl)ether dianhydride;
4,4′-oxydiphthalic dianhydride;
4,4′-bis(3,4-dicarboxyphenyl)sulfonic dianhydride;
bis(2,3-dicarboxyphenyl)methanoic dianhydride; and
bis(3,4-dicarboxyphenyl)diethylsilane dianhydride.

As the diamine, any suitable diamine can be selected. Examples of the diamine include:
2,2′-bis(trifluoromethyl)-4,4′-diaminobiphenyl;
4,4′-diaminobiphenyl;
4,4′-diaminophenylmethane;
4,4′-(9-fluorenylidene)-dianiline;
3,3′-dichloro-4,4′-diaminophenylmethane;
2,2′-dichloro-4,4′-diaminobiphenyl;
4,4′-diaminophenylether;
3,4′-diaminodiphenylether;
4,4′-diaminodiphenylsulfone; and
4,4′-diaminodiphenylthioether.

The weight-average molecular weight (Mw) of the polyimide resin, which is determined based on a polyethylene oxide standard using as a developing solvent a dimethylformamide solution (10 mM (mmol/l) lithium bromide and 10 mM (mmol/l) phosphoric acid was added up to the standard mark on a measuring flask to prepare 1 l of dimethylformamide solution) preferably is in the range from 20000 to 180000. Preferably, the polyimide resin has an imidization ratio of at least 95%. The imidization ratio of the polyimide resin can be determined based on the integral intensity ratio between a proton peak derived from polyamic acid as a precursor of polyimide and a proton peak derived from polyimide, for example.

The retardation film (B1) containing the polyimide resin can be obtained by any suitable processing method. Preferably, the retardation film (B1) is produced by being formed into a sheet-like shape by a solvent casting method.

[Cellulose Resin]

As the cellulose resin, any suitable cellulose resin can be employed. Preferably, the cellulose resin is cellulose organic acid ester or cellulose-mixed organic acid ester in which at least one or all of the hydroxyl groups contained in cellulose are substituted by at least one group selected from an acetyl group, a propionyl group, and a butyl group. Examples of the cellulose organic acid ester include cellulose acetate, cellulose propionate, and cellulose butyrate. Examples of the cellulose-mixed organic acid ester include cellulose acetate propionate and cellulose acetate butyrate. The cellulose resin can be obtained by the method described in the paragraphs [0040] and [0041] of JP 2001-188128 A, for example.

The weight-average molecular weight (Mw) of the cellulose resin, which is measured by gel permeation chromatography (with a polystyrene standard) using a tetrahydrofuran solvent, preferably is in the range from 20000 to 1000000. The glass transition temperature (Tg) of the cellulose resin preferably is in the range from 110° C. to 185° C. The glass transition temperature (Tg) can be determined by a DSC method according to JIS K 7121 (1987 version). With the use of the above-described resin, it is possible to obtain a retardation film having a still higher thermal stability and a still higher mechanical strength.

The retardation film (B2) containing the cellulose resin can be obtained by any suitable processing method. Preferably, the retardation film (B2) is produced by being formed into a sheet-like shape by a solvent casting method. As the retardation film (B2), it is possible to use a commercially available polymer film containing a cellulose resin as it is, for example. Alternatively, it is possible to use the commercially available film that has been subjected to secondary processing, e.g., at least one of a stretching treatment and a shrinking treatment. Examples of the commercially available film include “FUJITAC” (trade name) series (ZRF80S, TD80UF, TDY-80UL) manufactured by Fuji Photo Film Co., Ltd. and “KC8UX2M” (trade name) manufactured by Konica Minolta Opto, Inc.

The retardation film used as the second retardation layer may further contain any suitable additive. Examples of the additive include plasticizers, thermostabilizers, light stabilizers, lubricants, antioxidants, UV absorbers, flame retardants, colorants, antistatic agents, compatibilizers, crosslinking agents, and thickeners. The content of the additive preferably is more than 0 and not more than 10 parts by weight with respect to 100 parts by weight of the resin as a main component.

In the second retardation layer, a liquid crystalline composition may be used. When the liquid crystalline composition is used, the second retardation layer includes a solidified layer or a cured layer of a liquid crystalline composition containing a rod-shaped liquid crystal compound that is in a planar alignment, or a solidified layer or a cured layer of a liquid crystalline composition containing a discotic liquid crystal compound that is in a columnar alignment. When the liquid crystal compound is used, the birefringence in the thickness direction is great, so that a thin retardation film can be obtained.

The retardation film including a solidified layer or a cured layer of a liquid crystalline composition containing a rod-shaped liquid crystal compound that is in a planar alignment can be obtained by a method described in JP 2003-287623 A, for example. Furthermore, the retardation film including a solidified layer or a cured layer of a liquid crystalline composition containing a discotic liquid crystal compound that is in a columnar alignment can be obtained by the method described in JP 9 (1997)-117983 A, for example.

[D-5. Liquid Crystal Cell]

The liquid crystal cell is the same as the liquid crystal cell used in the first liquid crystal panel.

[D-6. Relationship Between First Polarizing Plate and Second Polarizing Plate]

It is preferable that the first polarizing plate and the second polarizing plate are arranged so that their absorption axes are orthogonal to each other. The thickness of the second polarizing plate is the same as that of the polarizing plate of the present invention (the first polarizing plate).

As described above, the transmittance (T₁) of the first polarizing plate preferably is in the range from 38.3% to 43.3%. By setting T₁ in the above-described range, it is possible to obtain a liquid crystal panel having a still higher contrast ratio in the front direction. It is more preferable that T₁ is in the range from 38.6% to 43.2%, still more preferably from 39.9% to 43.1%, and particularly preferably from 39.2% to 43.0%.

As described above, the transmittance (T₂) of the second polarizing plate preferably is in the range from 41.1% to 44.3%. By setting T₂ in the above-described range, it is possible to obtain a liquid crystal panel having a high contrast ratio in the front direction. It is more preferable that T₂ is in the range from 41.5% to 44.3%, still more preferably from 41.9% to 44.2%, and particularly preferably from 42.3% to 44.2%.

Examples of a method of increasing or decreasing the transmittance of the first polarizing plate and the second polarizing plate include, when a polarizer that contains a polyvinyl alcohol resin containing iodine is used in each of the first polarizing plate and the second polarizing plate, adjusting the iodine content in the polarizer. Specifically, by decreasing the iodine content in the polarizer, it is possible to increase the transmittance of each of the first polarizing plate and the second polarizing plate. This method is applicable to the production of a polarizer in a roll form and also to the production of each sheet of polarizer. The details of the polarizer are as described above.

As described above, the polarization ratio of at least one of the first polarizing plate and the second polarizing plate preferably is at least 99%. By setting the polarization ratio to at least 99%, it is possible to obtain a liquid crystal panel having a still higher contrast ratio in the front direction. It is more preferable that the polarization ratio is at least 99.5%, still more preferably 99.8%. The polarization ratio can be measured by, for example, using a spectrophotometer (Murakami Color Research Laboratory, trade name “DOT-3”). The specific measurement method of the polarization ratio is as follows. The parallel transmittance (H₀) and the crossed transmittance (H₉₀) of each of the first polarizing plate and the second polarizing plate are measured, and the polarization ratio can be determined based on an equation: polarization ratio (%)={(H₀−H₉₀)/(H₀+H₉₀)}^{1/2}×100. The parallel transmittance (H₀) is a transmittance of a parallel-type laminated polarizing plate produced by laminating two identical polarizing plates such that their absorption axes are parallel to each other. The crossed transmittance (H₉₀) is a transmittance of an orthogonal-type laminated polarizing plate produced by laminating two identical polarizing plates such that their absorption axes are orthogonal to each other. Note here that these transmittances are Y values whose luminous factors have been corrected in view of a two-degree visual field (C light source) according to JIS Z 8701 (1982 version).

[E. Liquid Crystal Display]

A liquid crystal display of the present invention is characterized in that it includes the polarizing plate or the liquid crystal panel according to the present invention. An example of the configuration of the liquid crystal display of the present invention is shown in the schematic sectional view of FIG. 5. In FIG. 5, the sizes, proportions, etc. of the respective components are different from the actual sizes, proportions, etc, for the sake of simplicity in illustration. As shown in FIG. 5, this liquid crystal display 200 includes at least a liquid crystal panel 100 and a direct-type backlight unit 80 arranged on one side of the liquid crystal panel 100. The direct-type backlight unit 80 includes at least light sources 81, a reflection film 82, a diffusion plate 83, a prism sheet 84, and a brightness enhancement film 85. Although the liquid crystal display 200 according to the present example employs the direct-type backlight unit, the present invention is not limited thereto, and a sidelight-type backlight unit can be used, for example. The sidelight-type backlight unit includes at least a light guide plate and a light reflector, in addition to the configuration of the direct-type backlight unit. Note here that the components shown in FIG. 5 for illustrative purposes can be omitted partially or substituted by another optical element depending on the lighting system of the liquid crystal display, the driving mode of the liquid crystal cell, the intended use, etc. as long as the effect of the present invention can be obtained.

The liquid crystal display of the present invention may be a transmission type liquid crystal display in which the screen is seen by being irradiated with light from the backlight side of the liquid crystal panel, may be a reflection type liquid crystal display in which the screen is seen by being irradiated with light from the visible side of the liquid crystal panel, or may be a semi-transmission type liquid crystal display having the properties of both the transmission type and the reflection type liquid crystal displays.

The liquid crystal display of the present invention is applicable to any suitable use. Examples of the use thereof include: office automation equipment such as computer monitors, notebook computers, and copy machines; portable devices such as mobile phones, watches, digital cameras, personal digital assistants (PDAs), and portable game devices; household electric appliances such as video cameras, televisions, and microwave ovens; vehicle-mounted devices such as back monitors, car navigation system monitors, and car audios; exhibition devices such as information monitors for commercial stores; security devices such as surveillance monitors; and nursing care and medical devices such as nursing-care monitors and medical monitors.

Preferably, the liquid crystal display of the present invention is used in a television. The screen size of the television preferably is a wide-screen 17-inch type (373 mm×224 mm) or larger, more preferably a wide-screen 23-inch type (499 mm×300 mm) or larger, and still more preferably a wide-screen 32-inch type (687 mm×412 mm) or larger.

### EXAMPLES

Hereinafter, examples of the present invention will be described together with comparative examples. It is to be noted, however, the present invention is by no means limited or restricted by the following examples and comparative examples. Measurement and evaluation of various characteristics and physical properties in the respective examples and comparative examples were performed by methods described below.

(Moisture Content of Polarizing Plate)

The moisture content of a polarizing plate was measured by the following method.

(1) Five samples with the size of 10 cm×10 cm were cut out from each polarizing plate at equal intervals in the width direction (TD direction). The weight of each of the samples was measured, and the value obtained was regarded as an initial sample weight (W0).
(2) Each sample was heat-treated by being placed in an oven (ESPEC Corp., trade name “CLEAN OVEN PVHC-211”) at 120° C. for at least 12 hours. Thereafter, the weight of each sample immediately after being taken out from the oven was measured, and the value obtained was regarded as a sample weight (W1) after the heat treatment.
(3) The moisture content (%) of each sample was calculated based on the following equation (II). An average value of the moisture contents of the five samples was regarded as the moisture content of the polarizing plate.

Moisture content(%)={(W0−W1)/W0}×100 (II)

W0: initial sample weight
W1: sample weight after heat treatment

(Strain of Polarizing Plate)

Strain of a polarizing plate was measured by the following method.

(1) A surface of a polarizing plate on the visible side of a liquid crystal panel was roughened (about 2 to 4 μm) using a tracing paper.
(2) To the roughened surface of the polarizing plate, a three-axis strain gauge (Tokyo Sokki Kenkyujo Co., Ltd., gauge type: FRA-5-1) was attached with an adhesive so as to achieve complete adhesion. At this time, measurement portions of four gauges of the strain gauge were attached to the apexes of a 10 cm×10 cm region in the central portion of the polarizing plate.
(3) The strain gauge was installed in a data logger (Tokyo Sokki Kenkyujo Co., Ltd.), and was set in a strain measurement mode.
(4) The liquid crystal panel was fixed using a jig so that it would stand upright at ordinary temperature (20° C. to 25° C.), and then it was put in an oven (ESPEC Corp., trade name “CLEAN OVEN PVHC-211”) at 50° C.±3° C.
(5) Assuming that the time when the polarizing plate was put in the oven was 0 minute, the change in strain of the polarizing plate with time was measured. Note here that the strain (με) of the polarizing plate is a value calculated based on the following equation (III).

με=ΔL/L (III)

L: gauge length
ΔL: gauge change length

(Black Luminance Ratio)

After a lapse of 30 minutes since the lighting of a backlight, black display was provided. Then, using a luminance distribution measurement device (Konica Minolta Holdings, Inc., trade name “CA-1500”), the black luminance ratio was calculated based on an equation:black luminance ratio=maximum luminance/minimum luminance. At this time, the liquid crystal panel was divided into 16 sections, namely, 4 sections in the width direction×4 sections in the longitudinal direction, and the lowest black luminance among black luminances in the four sections in the central portion was regarded as the minimum luminance, and the highest black luminance within the plane of the liquid crystal panel was regarded as the maximum luminance.

(Knicks)

After a lapse of 30 minutes since the lighting of a backlight in a darkroom at 23° C., the display surface (1 m×1 m=1 m²) at the time of black display was observed visually, and the presence or absence of knicks was determined based on the presence or absence of a bright point.

A: No knicks were observed (the number of knicks: 0).
B: Although some knicks were observed, they were in a practically acceptable level (the number of knicks: 1 to 5).
C: Knicks were observed, which were in a practically unacceptable level (the number of knicks: 6 or more).

(Retardation Values (Re[590], Rth[590]), Nz Coefficient, and T[590] at a Wavelength of 590 nm)

Retardation values (Re[590], Rth[590]), an Nz coefficient, and T[590] at a wavelength of 590 nm were measured at 23° C. using “KOBRA21-ADH” (trade name) manufacture by Oji Scientific Instruments. Note here that an average refractive index was determined by using measured values obtained with the use of an Abbe refractometer (Atago Co., Ltd., product name “DR-M4”).

(Thickness)

When the thickness was less than 10 μm, it was measured using a spectrophotometer for thin films (Otsuka Electronics Co., Ltd., trade name “INSTANT MULTI-PHOTOMETRY SYSTEM MCPD-2000”). When the thickness was 10 μm or more, it was measured using a digital micrometer “KC-351C” manufactured by Anritsu Corporation.

(Molecular Weight of Polyimide Resin)

The molecular weight of a polyimide resin was measured by gel permeation chromatography (GPC) using polystyrene oxide as a standard sample. Specifically, the measurement was carried out using the following apparatus and instruments and under the following measurement conditions.

Measurement sample: The sample was dissolved in an eluent to prepare a 0.1 wt % solution, which was allowed to stand still for 8 hours. Thereafter, the solution was filtered through a 0.45 μm thick membrane filter. The resultant filtrate was used as a measurement sample.
Analyzer: “HLC-8020GPC” (trade name) manufactured by Tosoh Corp.
Column: “GMH_{XL}+GMH_{XL}+G2500H_{XL}” (trade name) manufactured by Tosoh Corp.
Column size: each 7.8 mmφ×30 cm (90 cm in total)
Eluent dimethylformamide (10 mM lithium bromide and 10 mM phosphoric acid were added up to the standard mark on a measuring flask to prepare 1 l of dimethylformamide solution)
Flow rate: 0.8 ml/min
Detector: RI (differential refractometer)
Column temperature: 40° C.

### Transparent Protective Film

### Reference Example 1

A 80 μm thick TAC film (FUJIFILM Corporation, trade name “80UL”) was provided. This film was used as a transparent protective film.

### Polarizer

### Reference Example 2

A 75 μm thick polymer film containing a polyvinyl alcohol resin as a main component (Kuraray Co., Ltd., trade name “VF-PS#7500”) was immersed in five baths in the conditions described in [1] to [5] below with a tensile force being applied in the longitudinal direction of the film, whereby the film was stretched so that the final stretch ratio would be 6.2 times its original length. This stretched film was dried in an air circulation oven at 40° C. for 1 minute. Thus, a polarizer was produced.

### <Conditions>

[1] Swelling bath: pure water at 30° C.
[2] Dye bath: an aqueous solution at 30° C. containing 0.032 parts by weight of iodine and 0.2 parts by weight of potassium iodide with respect to 100 parts by weight of water
[3] First crosslinking bath: an aqueous solution at 40° C. containing 3 wt % potassium iodide and 3 wt % boric acid
[4] Second crosslinking bath: an aqueous solution at 60° C. containing 5 wt % potassium iodide and 4 wt % boric acid
[5] Washing bath: an aqueous solution at 25° C. containing 3 wt % potassium iodide

### First Optical Compensation Layer

### Reference Example 3

A 140 μm thick norbornene resin-containing polymer film (JSR Corporation, trade name “ARTON”) was stretched 2.8 times in an air circulation constant-temperature oven at 155° C. by a fixed-end transverse uniaxial stretching method (a method in which the film is stretched in its width direction with the longitudinal direction of the film being fixed) using a tenter stretching machine. Thus, a first optical compensation layer AR1 was produced. The refractive index of this first optical compensation layer AR1 had a relationship of nx>ny>nz. The first optical compensation layer AR1 had a thickness of 40 μm and the following optical characteristics: T[590]=91%, Re[590]=120 nm, Rth[590]=160 nm, Nz coefficient at a wavelength of 590 nm=1.33, and C[590]=4.0×10⁻¹² m²/N.

### Reference Example 4

8.8 g of a polyvinyl alcohol resin (Nippon Synthetic Chemical Industry Co., Ltd., trade name “NH-18” (polarization degree=1800, saponification degree=99.0%)) was dried at 105° C. for 2 hours and then dissolved in 167.2 g of dimethyl sulfoxide (DMSO). 2.98 g of 2-methoxy-1-naphthaldehyde and 0.80 g of p-toluenesulfonic acid monohydrate were added thereto, and the resultant mixture was stirred at 40° C. for 1 hour. 3.18 g of benzaldehyde was added to this reaction solution, and the resultant mixture was stirred at 40° C. for 1 hour. Thereafter, 23.60 g of 1,1-diethoxyethane (acetal) was further added thereto, and the resultant mixture was stirred at 40° C. for 3 hours. Thereafter, 2.13 g of triethylamine was added thereto to terminate the reaction. The thus-obtained crude product was precipitated again using 1 l of methanol. A polymer obtained by filtering this was dissolved in tetrahydrofuran. This was precipitated again with methanol. This was filtered and dried, whereby 11.5 g of a polymer was obtained. This polymer was measured by ¹H-NMR. As a result, it was found that this polymer had a repeating unit represented by the following formula (6) and the ratio (molar ratio) of l:m:n:o was 11:37:45:7, as shown below. Moreover, the glass transition temperature (Tg) of this polymer was measured by a differential scanning calorimeter and found to be 123° C. Furthermore, the absolute value (C[550]) of the photoelastic coefficient of this polymer was 2.4×10⁻¹¹ m²/N.

Result of ¹H-NMR (DMSO) measurement:
0.8-2.3 (main-chain methylene and methyl in an acetal moiety)
3.4-4.4 (main chain methine with an oxygen atom bound thereto, methyl in a methoxy group, and a hydroxyl group)
4.5-5.1 (methine in an acetal moiety)
5.4-5.9 (methine in a benzene moiety)
6.4 (methine in a 2-methoxynaphthalene moiety)
7.1-7.5 (2-methoxynaphthalene and aromatic proton in a benzene moiety)
7.7-8.8 (aromatic proton in a 2-methoxynaphthalene moiety)

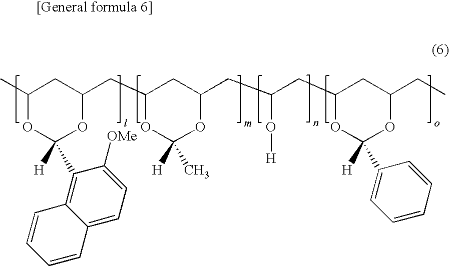

The above-described polymer was dissolved in methyl ethyl ketone (MEK), and the resultant mixture was casted on a base (PET) so that the thickness thereof became 110 μm after being dried. Thus, a polyvinyl acetal film was obtained. After peeling off the base, this film was stretched twice in the width direction at 140° C. according to a fixed-end stretching method using a stretching machine. Thus, a first optical compensation layer aR1 was produced. The refractive index of this first optical compensation layer aR1 had a relationship of nx>ny>nz. The first optical compensation layer aR1 had a thickness of 50 μm and the following optical characteristics: T[590]=92%, Re[590]=140 nm, Rth[590]=150 nm, and Nz coefficient at a wavelength 590 nm=1.07. Furthermore, this first optical compensation layer aR1 exhibited wavelength dependency of a reverse dispersion type.

### Second Optical Compensation Layer

### Reference Example 5

In a reaction vessel (500 ml) equipped with a mechanical stirrer, a Dean-Stark apparatus, a nitrogen inlet tube, a thermometer, and a cooling tube, 17.77 g (40 mmol) of 2,2-bis(3,4-dicarboxyphenyl)hexafluoropropane dianhydride (Clariant (Japan) K.K.) and 12.81 g (40 mmol) of 2,2-bis(trifluoromethyl)-4,4′-diaminobiphenyl (Wakayama Seika Kogyo Co., Ltd.) were added. Subsequently, a solution obtained by dissolving 2.58 g (20 mmol) of isoquinoline in 257.21 g of m-cresol was added, and the mixture was stirred (600 r/min) for 1 hour at 23° C., thus obtaining a uniform solution. Then, the reaction vessel was heated using an oil bath so that the temperature inside the reaction vessel would be 180° C.±3° C. While maintaining the temperature, the solution was stirred for 5 hours, thus obtaining a yellow solution. The solution further was stirred for 3 hours. Thereafter, heating and stirring were stopped, and the mixture was allowed to stand to cool to the room temperature, whereby a polymer was deposited in the gel form.

Acetone was added to the yellow solution in the reaction vessel so as to dissolve the gel completely, thus producing a diluted solution (7 wt %). This diluted solution was added to 21 of isopropyl alcohol gradually under stirring, and then white powder was deposited. This powder was filtered out and was put into 1.5 l of isopropyl alcohol for washing. The washing was completed by repeating the same operation once again, and thereafter, the powder was filtered out again. This was dried in an air circulation constant-temperature oven at 60° C. for 48 hours and then at 150° C. for 7 hours, thus obtaining polyimide powder represented by the following structural formula (7) with a yield of 85%. The weight-average molecular weight (Mw) of the polyimide was 124000 and the imidization ratio was 99.9%.

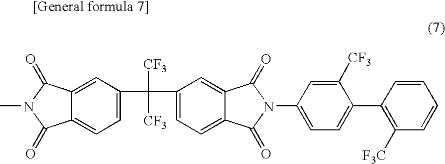

The polyimide powder was dissolved in methyl isobutyl ketone, thus preparing a 15 wt % polyimide solution. This polyimide solution was flow-expanded uniformly in a sheet-like shape on a surface of a TAC film (thickness: 80 μm) using a slot die coater. Then, the film was put in a multiple-chamber air circulation drying oven, and the solvent was evaporated by raising the temperature of the oven gradually from a low temperature, namely, at 80° C. for 2 minutes, at 135° C. for 5 minutes, and then at 150° C. for 10 minutes. Thus, a 3.7 μm thick laminate (C) including the polyimide layer and the TAC film was obtained. The refractive index of the laminate (C) had the relationship of nx=ny>nz (negative uniaxiality), and the laminate (C) had the following optical characteristics: T[590]=90%, Re[590]=1 nm, Rth[590]=210 nm. Note here that optical characteristics of the laminate (C) at a portion where the polyimide layer is provided were Rth[590]=150 nm and Δn_{xz}=0.04.

### Water-Soluble Adhesive Containing Polyvinyl Alcohol Resin and Metal Compound Colloid

### Reference Example 6

100 parts by weight of an acetoacetyl group-containing polyvinyl alcohol resin (Nippon Synthetic Chemical Industry Co., Ltd., trade name “GOHSEFIMER Z200”, average polymerization degree: 1200, saponification degree: 98.5 mol %, acetoacetylation degree: 5 mol %) and 50 parts by weight of methylol melamine were dissolved in pure water under a temperature condition of 30° C., thus obtaining an aqueous solution whose solid content had been adjusted to 3.7%. With respect to 100 parts by weight of this aqueous solution, 18 parts by weight of alumina colloid aqueous solution (average particle diameter: 15 nm, solid content: 10%, positively charged) were added, thus preparing a water-soluble adhesive. The water-soluble adhesive had a viscosity of 9.6 mPa·s and a pH of 4 to 4.5.

### Liquid Crystal Cell

### Reference Example 7

A liquid crystal panel was taken out from a commercially available liquid crystal display (Sony Corp., 32-inch liquid crystal television, trade name “BRAVIA”) including a VA mode liquid crystal cell, and optical films, such as polarizing plates, arranged on the upper and lower sides of the liquid crystal cell were all removed. Then, both sides of a glass plate of this liquid crystal cell were washed. Thus, a liquid crystal cell was obtained.

### Example 1

### First Polarizing Plate

On one side of the polarizer of Reference Example 2, the first optical compensation layer AR1 of Reference Example 3 was attached via a polyvinyl alcohol resin-containing water-soluble adhesive (Nippon Synthetic Chemical Industry Co., Ltd., trade name “GOHSEFIMER Z200”) in such a manner that the slow axis of the first optical compensation layer AR1 became orthogonal to the absorption axis of the polarizer. Then, on the other side of the polarizer, the transparent protective film of Reference Example 1 was attached via the water-soluble adhesive. The thus-obtained laminate was dried in an oven (Okazaki Machine Industry Co., Ltd.) at 60° C. to 90° C. for 5 minutes.

After the drying, the laminate was subjected to a heat treatment (annealing treatment) by being passed through an oven (Okazaki Machine Industry Co., Ltd.) at 80° C. for 10 minutes. Thus, a first polarizing plate AP1 was produced.

### Second Polarizing Plate

To each surface of the polarizer of Reference Example 2, the transparent protective film of Reference Example 1 was attached via a polyvinyl alcohol polymer-containing water-soluble adhesive (Nippon Synthetic Chemical Industry Co., Ltd., trade name “GOHSEFIMER Z200”). Thus, a second polarizing plate AP2 was produced.

[First Liquid Crystal Panel and Liquid Crystal Display]

On the visible side of the liquid crystal cell of Reference Example 7, the first polarizing plate AP1 was attached via an acrylic pressure-sensitive adhesive (thickness: 20 μm) in such a manner that the first optical compensation layer AR1 side became the liquid crystal cell side and the absorption axis direction of the first polarizing plate AP1 became parallel to the long-side direction of the liquid crystal cell. Then, on the backlight side of the liquid crystal cell, the second polarizing plate AP2 was attached via an acrylic pressure-sensitive adhesive (thickness: 20 μm) in such a manner that the absorption axis direction of the second polarizing plate AP2 became orthogonal to the long-side direction of the liquid crystal cell. Thus, a first liquid crystal panel AL1 was obtained. At this time, the absorption axis of the first polarizing plate AP1 was orthogonal to the absorption axis of the second polarizing plate AP2. The first liquid crystal panel AL1 then was bonded to a backlight unit included in the original liquid crystal display, thus producing a liquid crystal display AD1.

### Example 2

A first polarizing plate BP1, a first liquid crystal panel BL1, and a liquid crystal display BD1 were produced in the same manner as in Example 1, except that, in the production of the first polarizing plate, the heat treatment (annealing treatment) was performed by passing the laminate through an oven (Okazaki Machine Industry Co., Ltd.) at 75° C. for 10 minutes.

### Example 3

A first polarizing plate CP1, a first liquid crystal panel CL1, and a liquid crystal display CD1 were produced in the same manner as in Example 1, except that, in the production of the first polarizing plate, the heat treatment (annealing treatment) was performed by passing the laminate through an oven (Okazaki Machine Industry Co., Ltd.) at 75° C. for 8 minutes.

### Example 4

A first polarizing plate DP1, a first liquid crystal panel DL1, and a liquid crystal display DD1 were produced in the same manner as in Example 1, except that, in the production of the first polarizing plate, the heat treatment (annealing treatment) was performed by passing the laminate through an oven (Okazaki Machine Industry Co., Ltd.) at 60° C. for 23 minutes.

### Example 5

A first polarizing plate EP1, a first liquid crystal panel EL1, and a liquid crystal display ED1 were produced in the same manner as in Example 1, except that, in the production of the first polarizing plate, the water-soluble adhesive of Reference Example 6 was used to attach the first optical compensation layer to the polarizer.

### Example 6

A first polarizing plate FP1, a first liquid crystal panel FL1, and a liquid crystal display FD1 were produced in the same manner as in Example 2, except that, in the production of the first polarizing plate, the water-soluble adhesive of Reference Example 6 was used to attach the first optical compensation layer to the polarizer.

### Example 7

A first polarizing plate GP1, a first liquid crystal panel GL1, and a liquid crystal display GD1 were produced in the same manner as in Example 3, except that, in the production of the first polarizing plate, the water-soluble adhesive of Reference Example 6 was used to attach the first optical compensation layer to the polarizer.

### Example 8

A first polarizing plate HP1, a first liquid crystal panel HL1, and a liquid crystal display HD1 were produced in the same manner as in Example 4, except that, in the production of the first polarizing plate, the water-soluble adhesive of Reference Example 6 was used to attach the first optical compensation layer to the polarizer.

### Example 9

### First Polarizing Plate

A first polarizing plate AP1 was produced in the same manner as that for the first polarizing plate of Example 1.

### Second Polarizing Plate

On one side of the polarizer of Reference Example 2, the laminate (C) of Reference Example 5 was attached via a polyvinyl alcohol resin-containing water-soluble adhesive (Nippon Synthetic Chemical Industry Co., Ltd., trade name “GOHSEFIMER Z200”) in such a manner that the TAC film side of the laminate (C) faced the polarizer. Then, on the other side of the polarizer, the transparent protective film of Reference Example 1 was attached via the water-soluble adhesive. Thus, a second polarizing plate IP2 was produced.

[Second Liquid Crystal Panel and Liquid Crystal Display]

On the visible side of the liquid crystal cell of Reference Example 7, the first polarizing plate AP1 was attached via an acrylic pressure-sensitive adhesive (thickness: 20 μm) in such a manner that the first optical compensation layer AR1 side became the liquid crystal cell side and the absorption axis direction of the first polarizing plate AP1 became parallel to the long-side direction of the liquid crystal cell. Then, on the backlight side of the liquid crystal cell, the second polarizing plate IP2 was attached via an acrylic pressure-sensitive adhesive (thickness: 20 μm) in such a manner that the laminate (C) side became the liquid crystal cell side and the absorption axis direction of the second polarizing plate IP2 became orthogonal to the long-side direction of the liquid crystal cell. Thus, a second liquid crystal panel IL1 was obtained. At this time, the absorption axis of the first polarizing plate AP1 was orthogonal to the absorption axis of the second polarizing plate IP2. The second liquid crystal panel IL1 then was bonded to a backlight unit included in the original liquid crystal display, thus producing a liquid crystal display ID1.

### Example 10

A second liquid crystal panel JL1 and a liquid crystal display JD1 were produced in the same manner as in Example 9, except that the first polarizing plate BP1 produced in Example 2 was used as a first polarizing plate.

### Example 11

A second liquid crystal panel KL1 and a liquid crystal display KD1 were produced in the same manner as in Example 9, except that the first polarizing plate CP1 produced in Example 3 was used as a first polarizing plate.

### Example 12

A second liquid crystal panel LL1 and a liquid crystal display LD1 were produced in the same manner as in Example 9, except that the first polarizing plate DP1 produced in Example 4 was used as a first polarizing plate.

### Example 13

A second liquid crystal panel ML1 and a liquid crystal display MD1 were produced in the same manner as in Example 9, except that the first polarizing plate EP1 produced in Example 5 was used as a first polarizing plate.

### Example 14

A second liquid crystal panel NL1 and a liquid crystal display ND1 were produced in the same manner as in Example 9, except that the first polarizing plate FP1 produced in Example 6 was used as a first polarizing plate.

### Example 15

A second liquid crystal panel OL1 and a liquid crystal display OD1 were produced in the same manner as in Example 9, except that the first polarizing plate GP1 produced in Example 7 was used as a first polarizing plate.

### Example 16

A second liquid crystal panel PL1 and a liquid crystal display PD1 were produced in the same manner as in Example 9, except that the first polarizing plate HP1 produced in Example 8 was used as a first polarizing plate.

### Example 17

### First Polarizing Plate

On one side of the polarizer of Reference Example 2, the first optical compensation layer aR1 of Reference Example 4 was attached via a polyvinyl alcohol resin-containing water-soluble adhesive (Nippon Synthetic Chemical Industry Co., Ltd., trade name “GOHSEFIMER Z200”) in such a manner that the slow axis of the first optical compensation layer aR1 became orthogonal to the absorption axis of the polarizer. Then, on the other side of the polarizer, the transparent protective film of Reference Example 1 was attached via the water-soluble adhesive. The thus-obtained laminate was dried in an oven (Okazaki Machine Industry Co., Ltd.) at 60° C. to 90° C. for 5 minutes.

After the drying, the laminate was subjected to a heat treatment (annealing treatment) by being passed through an oven (Okazaki Machine Industry Co., Ltd.) at 80° C. for 9 minutes. Thus, a first polarizing plate aP1 was produced.

[Second Polarizing Plate]

A second polarizing plate AP2 was produced in the same manner as that for the second polarizing plate of Example 1.

[First Liquid Crystal Panel and Liquid Crystal Display]

On the visible side of the liquid crystal cell of Reference Example 7, the first polarizing plate aP1 was attached via an acrylic pressure-sensitive adhesive (thickness: 20 μm) in such a manner that the first optical compensation layer aR1 side became the liquid crystal cell side and the absorption axis direction of the first polarizing plate aP1 became parallel to the long-side direction of the liquid crystal cell. Then, on the backlight side of the liquid crystal cell, the second polarizing plate AP2 was attached via an acrylic pressure-sensitive adhesive (thickness: 20 μm) in such a manner that the absorption axis direction of the second polarizing plate AP2 became orthogonal to the long-side direction of the liquid crystal cell. Thus, a first liquid crystal panel aL1 according to the present example was obtained. At this time, the absorption axis of the first polarizing plate aP1 was orthogonal to the absorption axis of the second polarizing plate AP2. The first liquid crystal panel aL1 then was bonded to a backlight unit included in the original liquid crystal display, thus producing a liquid crystal display aD1.

### Example 18

A first polarizing plate bP1, a first liquid crystal panel bL1, and a liquid crystal display bD1 were produced in the same manner as in Example 17, except that, in the production of the first polarizing plate, the heat treatment (annealing treatment) was performed by passing the laminate through an oven (Okazaki Machine Industry Co., Ltd.) at 75° C. for 8 minutes.

### Example 19

A first polarizing plate cP1, a first liquid crystal panel cL1, and a liquid crystal display cD1 were produced in the same manner as in Example 17, except that, in the production of the first polarizing plate, the heat treatment (annealing treatment) was performed by passing the laminate through an oven (Okazaki Machine Industry Co., Ltd.) at 75° C. for 6 minutes.

### Example 20

A first polarizing plate dP1, a first liquid crystal panel dL1, and a liquid crystal display dD1 were produced in the same manner as in Example 17, except that, in the production of the first polarizing plate, the heat treatment (annealing treatment) was performed by passing the laminate through an oven (Okazaki Machine Industry Co., Ltd.) at 60° C. for 19 minutes.

### Example 21

A first polarizing plate eP1, a first liquid crystal panel eL1, and a liquid crystal display eD1 were produced in the same manner as in Example 17, except that, in the production of the first polarizing plate, the water-soluble adhesive of Reference Example 6 was used to attach the first optical compensation layer aR1 to the polarizer.

### Example 22

A first polarizing plate fP1, a first liquid crystal panel fL1, and a liquid crystal display fD1 were produced in the same manner as in Example 18, except that, in the production of the first polarizing plate, the water-soluble adhesive of Reference Example 6 was used to attach the first optical compensation layer aR1 to the polarizer.

### Example 23

A first polarizing plate gP1, a first liquid crystal panel gL1, and a liquid crystal display gD1 were produced in the same manner as in Example 19, except that, in the production of the first polarizing plate, the water-soluble adhesive of Reference Example 6 was used to attach the first optical compensation layer aR1 to the polarizer.

### Example 24

A first polarizing plate hP1, a first liquid crystal panel hL1, and a liquid crystal display hD1 were produced in the same manner as in Example 20, except that, in the production of the first polarizing plate, the water-soluble adhesive of Reference Example 6 was used to attach the first optical compensation layer aR1 to the polarizer.

### Example 25

### First Polarizing Plate

A first polarizing plate aP1 was produced in the same manner as that for the first polarizing plate of Example 17.

### Second Polarizing Plate

A second polarizing plate 1P2 was produced in the same manner as that for the second polarizing plate of Example 9.

[Second Liquid Crystal Panel and Liquid Crystal Display]

On the visible side of the liquid crystal cell of Reference Example 7, the first polarizing plate aP1 was attached via an acrylic pressure-sensitive adhesive (thickness: 20 μm) in such a manner that the first optical compensation layer aR1 side became the liquid crystal cell side and the absorption axis direction of the first polarizing plate aP1 became parallel to the long-side direction of the liquid crystal cell. Then, on the backlight side of the liquid crystal cell, the second polarizing plate 1P2 was attached via an acrylic pressure-sensitive adhesive (thickness: 20 μm) in such a manner that the laminate (C) side became the liquid crystal cell side and the absorption axis direction of the second polarizing plate 1P2 became orthogonal to the long-side direction of the liquid crystal cell. Thus, a second liquid crystal panel iL1 was obtained. At this time, the absorption axis of the first polarizing plate aP1 was orthogonal to the absorption axis of the second polarizing plate 1P2. The second liquid crystal panel iL1 then was bonded to a backlight unit included in the original liquid crystal display, thus producing a liquid crystal display iD1.

### Example 26

A second liquid crystal panel jL1 and a liquid crystal display jD1 were produced in the same manner as in Example 25, except that the first polarizing plate bP1 produced in Example 18 was used as a first polarizing plate.

### Example 27

A second liquid crystal panel kL1 and a liquid crystal display kD1 were produced in the same manner as in Example 25, except that the first polarizing plate cP1 produced in Example 19 was used as a first polarizing plate.

### Example 28

A second liquid crystal panel lL1 and a liquid crystal display lD1 were produced in the same manner as in Example 25, except that the first polarizing plate dP1 produced in Example 20 was used as a first polarizing plate.

### Example 29

A second liquid crystal panel mL1 and a liquid crystal display mD1 were produced in the same manner as in Example 25, except that the first polarizing plate eP1 produced in Example 21 was used as a first polarizing plate.

### Example 30

A second liquid crystal panel nL1 and a liquid crystal display nD1 were produced in the same manner as in Example 25, except that the first polarizing plate fP1 produced in Example 22 was used as a first polarizing plate.

### Example 31

A second liquid crystal panel oL1 and a liquid crystal display oD1 were produced in the same manner as in Example 25, except that the first polarizing plate gP1 produced in Example 23 was used as a first polarizing plate.

### Example 32

A second liquid crystal panel pL1 and a liquid crystal display pD1 were produced in the same manner as in Example 25, except that the first polarizing plate hP1 produced in Example 24 was used as a first polarizing plate.

### Comparative Example 1

A first polarizing plate QP1, a liquid crystal panel QL1, and a liquid crystal display QD1 were produced in the same manner as in Example 1, except that, in the production of the first polarizing plate, the heat treatment (annealing treatment) was performed by passing the laminate through an oven (Okazaki Machine Industry Co., Ltd.) at 70° C. for 7 minutes.

### Comparative Example 2

A first polarizing plate RP1, a liquid crystal panel RL1, and a liquid crystal display RD1 were produced in the same manner as in Example 1, except that, in the production of the first polarizing plate, the heat treatment (annealing treatment) was not performed.

### Comparative Example 3

A first polarizing plate qP1, a liquid crystal panel qL1, and a liquid crystal display qD1 were produced in the same manner as in Example 17, except that, in the production of the first polarizing plate, the heat treatment (annealing treatment) was performed by passing the laminate through an oven (Okazaki Machine Industry Co., Ltd.) at 70° C. for 6 minutes.

### Comparative Example 4

A first polarizing plate rP1, a liquid crystal panel rL1, and a liquid crystal display rD1 were produced in the same manner as in Example 17, except that, in the production of the first polarizing plate, the heat treatment (annealing treatment) was not performed.

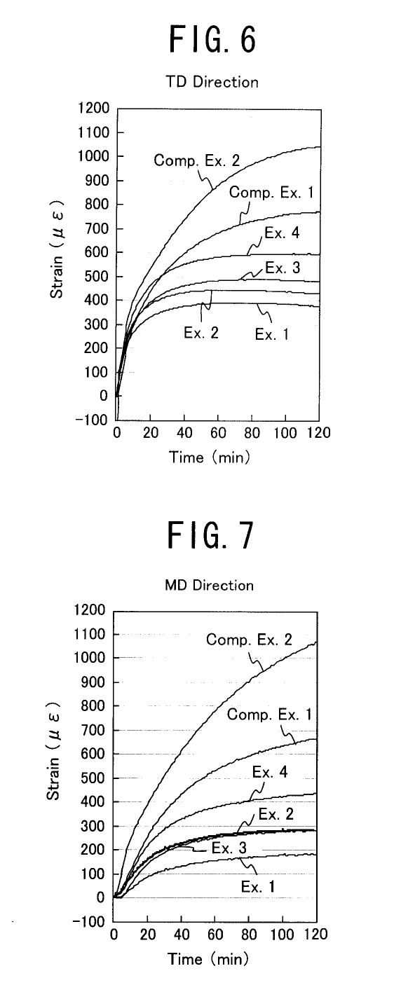

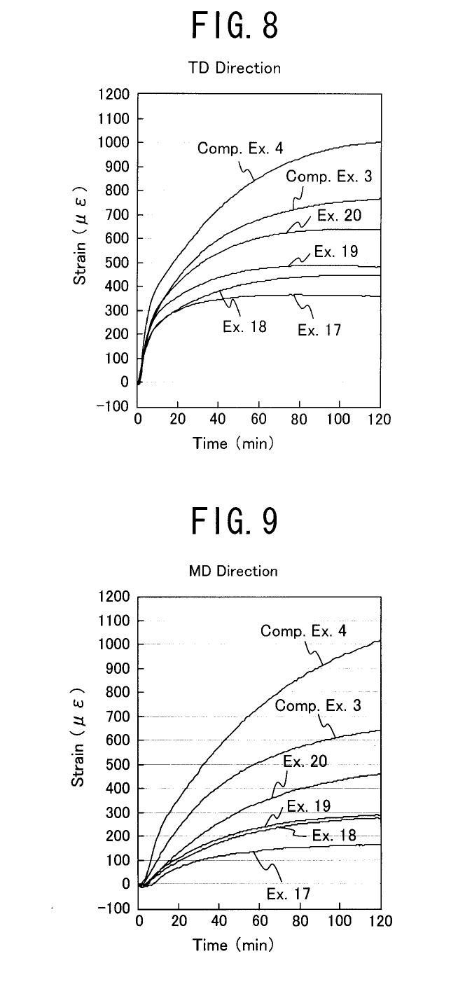

Various characteristics of the thus-obtained first polarizing plate, liquid crystal panel, and liquid crystal display of each of the examples and comparative examples were measured or evaluated. In the measurement of the strain of the polarizing plate, a cut piece of each polarizing plate with a size corresponding to ¼ of 32-inch size was used, and the strains of cut pieces of four kinds of different polarizing plates were measured simultaneously. The results of the measurement are shown in Table 1 below with regard to Examples 1 to 16 and Comparative Examples 1 and 2 and in Table 2 below with regard to Examples 17 to 32 and Comparative Examples 3 and 4. Furthermore, with regard to Examples 1 to 4 and Comparative Examples 1 and 2, the change with time in the strain of each polarizing plate in the transverse direction (TD direction) is shown in the graph of FIG. 6, and the change with time in the strain of each polarizing plate in the machine direction (MD direction) is shown in the graph of FIG. 7. With regard to Examples 17 to 20 and Comparative Examples 3 and 4, the change with time in the strain of each polarizing plate in the transverse direction (TD direction) is shown in the graph of FIG. 8, and the change with time in the strain of each polarizing plate in the machine direction (MD direction) is shown in the graph of FIG. 9. In Tables 1 and 2 below, “TD strain” indicates the strain of each polarizing plate in the transverse direction (TD direction) after the polarizing plate had been in the oven at 50° C.±3° C. for 120 minutes, and “MD strain” indicates the strain of each polarizing plate in the machine direction (MD direction) after the polarizing plate had been in the oven at 50° C.±3° C. for 120 minutes.

TABLE 1

| | Annealing | | | | | | |
|---|---|---|---|---|---|---|---|
| | treatment | | | | | | |
| | conditions | | Moisture | TD | MD | Black | |
| | Temp. | Time | content | strain | strain | luminance | |
| | (° C.) | (min) | (%) | (με) | (με) | ratio | Knicks |
| Ex. 1 | 80 | 10 | 1.32 | 379 | 182 | 1.49 | B |
| Ex. 2 | 75 | 10 | 1.68 | 431 | 284 | 1.65 | B |
| Ex. 3 | 75 | 8 | 1.95 | 483 | 283 | 1.70 | B |
| Ex. 4 | 60 | 23 | 2.47 | 597 | 438 | 1.80 | B |
| Ex. 5 | 80 | 10 | 1.32 | 379 | 182 | 1.49 | A |
| Ex. 6 | 75 | 10 | 1.68 | 431 | 284 | 1.65 | A |
| Ex. 7 | 75 | 8 | 1.95 | 483 | 283 | 1.70 | A |
| Ex. 8 | 60 | 23 | 2.47 | 597 | 438 | 1.80 | A |
| Ex. 9 | 80 | 10 | 1.32 | 379 | 182 | 1.49 | B |
| Ex. 10 | 75 | 10 | 1.68 | 431 | 284 | 1.65 | B |
| Ex. 11 | 75 | 8 | 1.95 | 483 | 283 | 1.70 | B |
| Ex. 12 | 60 | 23 | 2.47 | 597 | 438 | 1.80 | B |
| Ex. 13 | 80 | 10 | 1.32 | 379 | 182 | 1.49 | A |
| Ex. 14 | 75 | 10 | 1.68 | 431 | 284 | 1.65 | A |
| Ex. 15 | 75 | 8 | 1.95 | 483 | 283 | 1.70 | A |
| Ex. 16 | 60 | 23 | 2.47 | 597 | 438 | 1.80 | A |
| Comp. | 70 | 7 | 3.29 | 775 | 668 | 2.05 | B |
| Ex. 1 | | | | | | | |

| | | | | | | |
|---|---|---|---|---|---|---|
| Comp. | — | 6.20 | 1049 | 1075 | 2.50 | B |
| Ex. 2 | | | | | | |

TABLE 2

| | Annealing | | | | | | |
|---|---|---|---|---|---|---|---|
| | treatment | | | | | | |
| | conditions | | Moisture | TD | MD | Black | |
| | Temp. | Time | content | strain | strain | luminance | |
| | (° C.) | (min) | (%) | (με) | (με) | ratio | Knicks |
| Ex. 17 | 80 | 9 | 1.29 | 359 | 165 | 1.47 | B |
| Ex. 18 | 75 | 8 | 1.70 | 448 | 278 | 1.67 | B |
| Ex. 19 | 75 | 6 | 1.93 | 484 | 289 | 1.72 | B |
| Ex. 20 | 60 | 19 | 2.59 | 640 | 463 | 1.83 | B |
| Ex. 21 | 80 | 9 | 1.29 | 359 | 165 | 1.47 | A |
| Ex. 22 | 75 | 8 | 1.70 | 448 | 278 | 1.67 | A |
| Ex. 23 | 75 | 6 | 1.93 | 484 | 289 | 1.72 | A |
| Ex. 24 | 60 | 19 | 2.59 | 640 | 463 | 1.83 | A |
| Ex. 25 | 80 | 9 | 1.29 | 359 | 165 | 1.47 | B |
| Ex. 26 | 75 | 8 | 1.70 | 448 | 278 | 1.67 | B |
| Ex. 27 | 75 | 6 | 1.93 | 484 | 289 | 1.72 | B |
| Ex. 28 | 60 | 19 | 2.59 | 640 | 463 | 1.83 | B |
| Ex. 29 | 80 | 9 | 1.29 | 359 | 165 | 1.47 | A |
| Ex. 30 | 75 | 8 | 1.70 | 448 | 278 | 1.67 | A |
| Ex. 31 | 75 | 6 | 1.93 | 484 | 289 | 1.72 | A |
| Ex. 32 | 60 | 19 | 2.59 | 640 | 463 | 1.83 | A |
| Comp. | 70 | 6 | 3.26 | 767 | 645 | 2.01 | B |
| Ex. 3 | | | | | | | |

| | | | | | | |
|---|---|---|---|---|---|---|
| Comp. | — | 6.02 | 1003 | 1016 | 2.43 | B |
| Ex. 4 | | | | | | |

As can be seen from Tables 1 and 2, in the first polarizing plates of Examples 1 to 32 with the moisture content of not more than 3%, the strain of the polarizing plates was suppressed. The liquid crystal displays respectively using these first polarizing plates exhibited a low black luminance ratio of 1.83 or less, which demonstrates that the occurrence of luminance nonuniformity during the black display was prevented. In contrast, the strain was generated in the first polarizing plates of Comparative Examples 1 to 4 with the moisture content of 3% or more. In the liquid crystal displays respectively using these first polarizing plates exhibited a high black luminance ratio of 2.01 or more, which indicates that luminance nonuniformity occurred during the black display. Moreover, although the evaluation result of knicks was B in Examples 1 to 4, 9 to 12, 17 to 20, 25 to 28 and Comparative Examples 1 to 4, the evaluation result of knicks was A in Examples 5 to 8, 13 to 16, 21 to 24 and 29 to 32, in which the polyvinyl alcohol resin-containing water-soluble adhesive that contained the metal compound colloid was used for the lamination of the polarizer and the first optical compensation layer.

### INDUSTRIAL APPLICABILITY

As described above, in the polarizing plate of the present invention, even slight luminance nonuniformity is prevented from occurring. Examples of the use of the polarizing plate of the present invention, and the liquid crystal panel and the liquid crystal display each using the same include: office automation equipment such as desktop computers, notebook computers, and copy machines; portable devices such as mobile phones, watches, digital cameras, personal digital assistants (PDAs), and portable game devices; household electric appliances such as video cameras, televisions, and microwave ovens; vehicle-mounted devices such as back monitors, car navigation system monitors, and car audios; exhibition devices such as information monitors for commercial stores; security devices such as surveillance monitors; and nursing care and medical devices such as nursing-care monitors and medical monitors. There is no limitation on the use thereof, and they are applicable to a wide range of fields.

While detailed embodiments have been used to illustrate the invention, to those skilled in the art, however, it will be apparent from the foregoing disclosure that various changes and modifications can be made therein without departing from the sprit and scope of the invention. Furthermore, the foregoing description of the embodiments according to the present invention is provided for illustration only, and is not intended limit the invention.

1. A polarizing plate comprising:
a transparent protective film;
a polarizer formed on the transparent film; and
an optical compensation layer formed on the polarizer,
wherein the optical compensation layer comprises a retardation film containing at least one resin selected from the group consisting of norbornene resins, polyvinyl acetal resins, polyester resins, polypropylene resins, polycarbonate resins, and acrylic resins,
wherein a moisture permeability of the transparent protective film is different from a moisture permeability of the optical compensation layer,
wherein a moisture content of the polarizing plate is not more than 3%, and
a strain (με) in a TD direction is 700 or less and a strain (με) in a MD direction is 600 or less after the polarizing plate is heat-treated at 50° C.±3° C. for 120 minutes.

2. The polarizing plate according to claim 1, wherein the optical compensation layer has an Nz coefficient in a range from 1 to 2.

3. The polarizing plate according to claim 1, wherein the polarizer and the optical compensation layer are laminated via an adhesive layer formed of a water-soluble adhesive containing a polyvinyl alcohol resin.

4. The polarizing plate according to claim 3, wherein the water-soluble adhesive containing a polyvinyl alcohol resin further contains a metal compound colloid, and the adhesive layer contains a metal compound fine particle derived from the metal compound colloid.

5. The polarizing plate according to claim 1, wherein the transparent protective film is a triacetylcellulose film.

6. (canceled)

7. A liquid crystal panel comprising:
a liquid crystal cell, and
a polarizing plate,
wherein the polarizing plate is the polarizing plate according to claim 1, and
the polarizing plate is arranged on at least one side of the liquid crystal cell with the optical compensation layer being on the liquid crystal cell side.

8. A liquid crystal panel comprising:
a first polarizing plate;
a second polarizing plate; and
a liquid crystal cell,
wherein the first polarizing plate is the polarizing plate according to claim 1,
in the first polarizing plate, the transparent protective film is a first transparent protective film, the polarizer is a first polarizer, and the optical compensation layer is a first optical compensation layer,
in the second polarizing plate, a second transparent protective film, a second polarizer, and a second optical compensation layer are laminated in this order,
the first polarizing plate is arranged on a visible side of the liquid crystal cell with the first optical compensation layer being on the liquid crystal cell side, and
the second polarizing plate is arranged on a backlight side of the liquid crystal cell with the second optical compensation layer being on the liquid crystal cell side.

9. The liquid crystal panel according to claim 8, wherein
a refractive index of the first optical compensation layer has a relationship of nx>≧nz, a refractive index of the second optical compensation layer has a relationship of nx=ny>nz, and a transmittance (T₂) of the second polarizing plate is greater than a transmittance (T₁) of the first polarizing plate.

10. The liquid crystal panel according to claim 9, wherein a difference (ΔT=T₂−T₁) between the transmittance (T₂) of the second polarizing plate and the transmittance (T₁) of the first polarizing plate is in a range from 0.1% to 6.0%.

11. The liquid crystal panel according to claim 9, wherein the transmittance (T₁) of the first polarizing plate is in a range from 38.3% to 43.3%.

12. The liquid crystal panel according to claim 9, wherein the transmittance (T₂) of the second polarizing plate is in a range from 41.1% to 44.3%.

13. The liquid crystal panel according to claim 8, wherein the second optical compensation layer comprises a retardation film containing at least one thermoplastic resin selected from the group consisting of polyimide resins, cellulose resins, norbornene resins, polycarbonate resins, and polyamide resins.

14. The liquid crystal panel according to claim 8, wherein the second optical compensation layer is any one of a retardation layer (B1) containing a polyimide resin, a retardation layer (B2) containing a cellulose resin, and a laminate (C) including the retardation layer (B1) and the retardation layer (B2).

15. The liquid crystal panel according to claim 7, wherein the liquid crystal cell is a VA mode liquid crystal cell.

16. The liquid crystal panel according to claim 8, wherein the liquid crystal cell is a VA mode liquid crystal cell.

17. A liquid crystal display comprising a polarizing plate, wherein the polarizing plate is the polarizing plate according to claim 1.

18. A liquid crystal display comprising a liquid crystal panel, wherein the liquid crystal panel is the liquid crystal panel according to claim 7.

19. A liquid crystal display comprising a liquid crystal panel, wherein the liquid crystal panel is the liquid crystal panel according to claim 8.
